(19) United States
(12) Patent Application Publication
(10) Pub. No.: US 2006/0159838 A1
(43) Pub. Date: Jul. 20, 2006

(54) Controlling ink migration during the formation of printable electronic features

(75) Inventors: Mark H. Kowalski, Albuquerque, NM (US); Scott Thomas Haubrich, Albuquerque, NM (US); Anthony R. James, Rio Rancho, NM (US)

Correspondence Address: CABOT CORPORATION, 5401 VENICE AVENUE NE, ALBURQUERQUE, NM, 87113, US

(73) Assignee: Cabot Corporation, Boston, MA (US)

(21) Appl. No.: 11/331,185

(22) Filed: Jan. 13, 2006

Related U.S. Application Data
(60) Provisional application No. 60/643,577, filed on Jan. 14, 2005.
(60) Provisional application No. 60/643,629, filed on Jan. 14, 2005.
(60) Provisional application No. 60/643,578, filed on Jan. 14, 2005.
(60) Provisional application No. 60/695,403, filed on Jul. 1, 2005.

(51) Int. Cl. B05D 5/12; B05D 3/00; B05D 1/36

(52) U.S. Cl. 427/58; 427/299; 427/258

(57) ABSTRACT

Processes for controlling ink migration during the formation of printable electronic features. In a preferred aspect, the invention is to a process for forming at least a portion of an electronic feature. The process includes the steps of: (a) providing a first substrate having a first surface; (b) modifying the first surface to form a modified surface; and (c) applying an ink to at least a portion of the modified surface, wherein the modified surface interacts with the ink to inhibit lateral and/or longitudinal migration of the applied ink, and wherein the applied ink forms at least a portion of the electronic feature. In another aspect, the invention is to a process for encouraging electronic ink spreading with a surfactant.

### CROSS REFERENCE TO RELATED APPLICATIONS

This application claims priority to U.S. Provisional Patent Application Ser. Nos. 60/643,577; 60/643,629; and 60/643,378; all filed on Jan. 14, 2005, and to U.S. Provisional Patent Application Ser. No. 60/695,403, filed on Jul. 1, 2005, the entireties of which are incorporated herein by reference.

### FIELD OF THE INVENTION

The present invention relates to controlling ink migration during the formation of printable electronic features. More particularly, the invention relates to controlling migration of an ink on a substrate during the formation of the printable electronic features.

### BACKGROUND OF THE INVENTION

The electronics, display and energy industries rely on the formation of coatings and patterns of conductive materials to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

One consideration with respect to patterning of conductors or other electronic features is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, low viscosity compositions are not as well developed as the high viscosity compositions.

Ink-jet printing of conductors and other electronic features has been explored, but the approaches to date have been inadequate for producing well-defined features with good electrical properties, particularly at relatively low temperatures. Specifically, the need exists for processes to limit ink spreading during the formation of printable electronic features so that small printable electronic features may be quickly and repeatably manufactured. The need also exists for processes for limiting ink wetting.

Due to the limitations caused by spreading and wetting problems during the formation of printable electronic features, the need exists for compositions that can be deposited with a fine feature size, such as not greater than about 100 μm, while still providing electronic features with adequate electrical and mechanical properties.

### SUMMARY OF THE INVENTION

The present invention is directed to processes for limiting longitudinal and/or lateral ink migration during the formation of printable electronic features. In one embodiment, the invention is to a process for forming at least a portion of an electronic feature, the process comprising the steps of: (a) providing a first substrate having a first surface; (b) modifying the first surface to form a modified surface; and (c) applying an ink (e.g., using a direct write printing process) to at least a portion of the modified surface, wherein the modified surface interacts with the ink to inhibit one or both lateral migration and/or longitudinal migration of the applied ink, and wherein the applied ink forms at least a portion of the electronic feature.

The first surface optionally has a first surface energy and the modified surface has a second surface energy greater than the first surface energy. Alternatively, the second surface energy is less than the first surface energy. The absolute value of the difference between the first surface energy and the second surface energy, in one aspect, is greater than about 10 dynes/cm.

In one embodiment, the first substrate comprises a base substrate and a hydrophobic layer disposed thereon, and step (b) comprises removing a portion of the hydrophobic layer to form the modified surface. The process optionally further comprises the step of applying a hydrophobic layer to an initial substrate to form the first substrate. The removing may be achieved by etching, lasing, or by applying a chemical to a portion of the first substrate. The hydrophobic layer optionally comprises a component selected from the group consisting of a polymer, a wax, a curable polymer, and a passivation agent.

In a related embodiment, the first substrate comprises a base substrate and a hydrophilic layer disposed thereon, and step (b) comprises removing a portion of the hydrophilic layer to form the modified surface. For example, the base substrate optionally comprises glass and the hydrophilic layer comprises a component selected from the group consisting of a strong base, a hydrophilic coupling agent, and a hydrophilic polymer. The process optionally further comprises the step of applying a hydrophilic layer to an initial substrate to form the first substrate. Here too, the removing may be achieved by etching, lasing, or by applying a chemical to a portion of the first substrate.

The ink optionally comprises a metallic composition, which optionally comprises a metal selected from the group consisting of silver, gold, copper, nickel, cobalt, palladium, platinum, indium, tin, zinc, titanium, chromium, tantalum, tungsten, iron, rhodium, iridium, ruthenium, osmium and lead. In another aspect, the metallic composition comprises an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium and lead. For example, the alloy optionally comprises a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold. The alloy may comprise at least three metals.

In one aspect of the invention, the modified surface includes pores, which may be formed, for example, by laser patterning or photolithography. In this aspect, capillary forces may pull at least some portion of the ink into the pores to inhibit migration of the applied ink.

In another embodiment, the invention is to a process for forming at least a portion of an electronic feature, the process comprising the steps of: (a) providing a first substrate having a base substrate and a barrier layer disposed thereon; and (b) applying an ink on to (or adjacent to) at least a portion of the barrier layer, wherein the barrier layer interacts with the ink to inhibit either or both lateral migration and/or longitudinal migration of the applied ink, and wherein the applied ink ultimately forms at least a portion of the electronic feature. The process optionally further comprises the step of applying a barrier ink on the base substrate to form the first substrate. In this aspect, the process optionally further comprises the step of curing or heating the barrier ink under conditions effective to form the barrier layer.

In another embodiment, the invention is to a process for forming at least a portion of an electronic feature, the process comprising the steps of: (a) providing a substrate; (b) applying a first layer on the substrate, wherein the first layer comprises an adhesion promoter; and (c) applying a second layer on at least a portion of the first layer, wherein the first layer interacts with the second layer to inhibit one or both of lateral migration of the second layer and/or longitudinal migration of the second layer, and wherein the second layer forms the at least a portion of the electronic feature. The adhesion promoter may be selected from the group consisting of a polymer, PVP, a micro-mechanical adhesion promoter, silica, alumina, HF, an imide, and an ester. Optionally, the second layer comprises a metal selected from the group consisting of silver, gold, copper, nickel, rhodium, palladium and platinum.

In another embodiment, the invention is to a process for forming at least a portion of an electronic feature, the process comprising the steps of: (a) providing a substrate; (b) forming a first layer on the substrate, wherein the first layer is either cationic or anionic; and (c) forming a second layer on the first layer, at least in part, wherein the second layer is anionic if the first layer is cationic, wherein the second layer is cationic if the first layer is anionic, wherein the first layer interacts with the second layer at an interface between the first and second layers to inhibit one or both lateral migration and/or longitudinal migration of the second layer, and wherein the second layer forms the at least a portion of the electronic feature.

In one aspect of this embodiment, the first layer interacts with the second layer to form a barrier composition at an interface between the first and second layers, which barrier composition inhibits either or both lateral migration and/or longitudinal migration of the second layer. For example, the barrier composition may comprise a gelation or precipitant product of a reaction between a first reactant in the first layer and a second reactant in the second layer. In this aspect, the first layer optionally comprises a component selected from the group consisting of: a cationic polymer, a quaternary amine polymer, quarternary PVP, poly allyl chloride, and polyethylene imine. The second layer optionally comprises a metal selected from the group consisting of silver, gold, copper, nickel, rhodium, palladium and platinum.

In another embodiment, the invention is to a process for facilitating ink spreading. For example, in one embodiment the invention is to a process for forming at least a portion of an electronic feature, the process comprising the steps of: (a) providing a substrate; (b) forming a first layer on the substrate, wherein the first layer comprises a surfactant; and (c) contacting a second layer with the first layer, at least in part, under conditions effective to cause the second layer to spread laterally to a greater extent than if the second layer were formed on the substrate without the first layer, wherein the second layer forms the at least a portion of the electronic feature. The surfactant may be selected from the group consisting of a fluoronated surfactant, a non-ionic surfactant, and a charged surfactant. The second layer optionally comprises a metal selected from the group consisting of silver, gold, copper, nickel, rhodium, palladium and platinum.

In each embodiment, the substrate (e.g., the first substrate) optionally comprises a composition selected from the group consisting of FR4, a fluorinated polymer, polyimide, epoxy resin, polycarbonate, polyester, polyethylene, polypropylene, polyvinyl chloride, ABS copolymer, wood, paper, metallic foil, glass, flexible fiberboard, non-woven polymeric fabric, and cloth.

In each of the processes of the present invention, the electronic feature may be selected from the group consisting of a conductor, a resistor, a capacitor, an inductor, a dielectric and a semiconductor.

### BRIEF DESCRIPTION OF THE DRAWINGS

The present invention will be better understood in view of the following non-limiting figures, wherein:

FIG. 1 illustrates an additive approach for inhibiting lateral ink migration;

FIG. 2 illustrates another additive approach for inhibiting lateral ink migration;

FIG. 3 illustrates an additive approach for inhibiting longitudinal ink migration;

FIGS. 4A-4C illustrate a subtractive approach for limiting lateral ink migration; and

FIGS. 5A and 5B illustrate how substrate porosity may inhibit lateral and longitudinal ink migration.

### DETAILED DESCRIPTION OF THE INVENTION

### I. INTRODUCTION

The present invention is directed to processes for controlling ink migration during the formation of printable electronic features. In one aspect, the inventive process comprises the steps of: (a) providing a first substrate having a first surface; (b) modifying the first surface to form a modified surface; and (c) applying an electronic ink (which optionally comprises metallic and/or non-metallic nanoparticles) on or adjacent to at least a portion of the modified surface, wherein the modified surface interacts with the ink to inhibit either or both lateral migration and/or longitudinal migration of the applied electronic ink, and wherein the applied ink forms at least a portion of the electronic feature.

In a preferred aspect, the first surface has a first surface energy and the modified surface has a second surface energy greater than the first surface energy. In this aspect, the ink preferably is a hydrophilic ink. In an alternative embodiment, step (b) comprises modifying the first surface to form a modified surface having a second surface energy less than the first surface energy. In this aspect, the ink preferably is a hydrophobic ink.

The modifying of the first surface to form the modified surface (optionally having a second surface energy greater than or less than the first surface energy, as described above) may by achieved by a variety of modification techniques. A non-limiting list of examples of steps for modifying the first surface includes: (1) providing a physical barrier composition to inhibit lateral and/or longitudinal ink migration; (2) modifying substrate surface energy; (3) applying an adhesion promoter to a substrate; (4) forming a region having an opposite charge relative to the ink to be applied; and (5) selectively providing regions of increased or decreased porosity (in number and/or size) relative to the unmodified substrate.

In another aspect, the invention is to a process for enhancing ink spreading during the formation of a printable electronic feature. In this aspect, the process comprises the steps of: (a) providing a substrate; (b) forming a first layer on the substrate, wherein the first layer comprises a surfactant; and (c) contacting a second layer with the first layer, at least in part, under conditions effective to cause the second layer to spread laterally to a greater extent than if the second layer were formed on the substrate without the first layer, wherein the second layer forms the at least a portion of the electronic feature.

As used herein, the term “lateral” means a direction substantially parallel to a substrate surface and the term “longitudinal” means a direction substantially perpendicular to the substrate surface. The term “proximal” means the longitudinal direction extending toward the substrate surface, and the term “distal” means the longitudinal direction extending away from the substrate surface.

Additionally, the term “ink spreading” is used herein to generically refer to lateral migration of an ink on a substrate surface, while the term “ink penetration” is used to refer to longitudinal ink migration of an ink into a substrate, i.e., proximal migration of an ink on (and potentially into) a substrate.

### II. PRINTABLE ELECTRONIC FEATURES AND PROCESSES FOR MAKING PRINTABLE ELECTRONIC FEATURES

The present invention is suited for controlling ink migration during the formation of printable electronic features. Many printable electronic features and processes for making printable electronic features from one or more inks are known and are disclosed in, for example, U.S. Provisional Patent Application Ser. Nos. 60/643,577; 60/643,629; and 60/643,378; all filed on Jan. 14, 2005, the entireties of which are incorporated herein by reference. See also Published U.S. Patent Application Nos. US2003/0161959 A1 filed on Nov. 1, 2002; US2003/0108664 A1 Oct. 4, 2002; US2003/0124259 A1 Oct. 4, 2002; US2003/0175411 A1 Oct. 4, 2002; US2003/0180451 A1 Oct. 4, 2002; and US2003/0148024 A1 Oct. 4, 2002; the entireties of which are incorporated herein by reference. The processes disclosed in the above-referenced patent applications relate to forming various electronic features from one or more electronic inks. As used herein, the term “electronic ink” means an ink suitable for printing, e.g., direct write printing, to form at least a portion of an electronic feature. According to this definition, an electronic ink may or may not be electronic. That is, the electronic ink, prior to printing, may or may not allow for the flow of electrons, e.g., be conductive.

A brief overview of electronic inks, processes for forming electronic features from electronic inks, substrates, and the various electronic features that may be formed by the processes of the present invention will now be provided.

A. Electronic Ink Compositions

The electronic inks used to form electronic features may comprise a variety of different compositions. In various embodiments, the electronic ink used to form an electronic feature may comprise one or more of the following: particulates (metallic and/or non-metallic), one or more metal precursors, a liquid vehicle, an anti-agglomeration agent, a reducing agent, one or more additives (such as, but not limited to surfactants, polymers, biocides, thickeners, etc.) or other components.

1. Particulates

The electronic ink optionally includes metallic or non-metallic particulate material(s). In one embodiment, the particles comprise microparticles, defined herein as particles having an average particle size (d50 value) of not greater than about 10 microns, not greater than 5 microns, not greater than 2 microns, or not greater than 1 micron. The particles preferably comprise nanoparticles, which have an average particle size of not greater than about 500 nanometers, preferably not greater than about 100 nanometers. In terms of ranges, the nanoparticles preferably have an average particle size of from about 10 to 80 nanometers, e.g., from about 25 to 75 nanometers, and are not substantially agglomerated.

In one embodiment, the solids loading of particles in the electronic ink is as high as possible without adversely affecting the viscosity or other necessary properties of the composition. For example, the low viscosity precursor composition can have a particle loading of up to about 75 volume percent. If included in the electronic ink, the electronic ink preferably comprises at least about 1 volume percent or at least about 5 volume percent particulates. In another embodiment, the electronic ink optionally comprises at least about 10 volume percent or at least about 15 volume percent particulates. In terms of ranges, the electronic ink optionally comprises from about 1 to about 60 volume percent particulates, e.g., from about 10 to about 60 volume percent, or from about 30 to about 40 volume percent particulates, based on the total weight of the electronic ink. Preferably, the particle loading does not exceed about 40 volume percent particularly where adequate flow properties must be maintained for the electronic ink.

Some examples of ceramic materials for optional inclusion in the particles include one or more of oxides, sulfides, carbides, nitrides, borides, tellurides, selenides, phosphides, oxycarbides, oxynitrides, titanates, zirconates, stannates, silicates, aluminates, tantalates, tungstates, glasses, doped and mixed metal oxides. For example SiC, and BN are ceramics with high heat transfer coefficients and can be used in heat transfer fluids. Specific examples of some preferred oxides include silica, alumina, titania, magnesia, indium oxide, indium tin oxide and ceria. Moreover, the composition of the particles may be designed for any desired application. For example, alloy particles could include materials for hydrogen storage, such as LaNi, FeTi, Mg₂Ni, ZrV₂; or materials for magnetic applications, such as, CoFe, CoFe₂, FeNi, FePt, FePd, CoPt, CoPd, SmCo₅, Sm₂Co₁₇, Nd/B/Fe. For example, the particles could be core shell particles, such as, metals coating metals (Ag/Cu, Ag/Ni), metals coating metal oxides (Ag/Fe₃O₄), metal oxides coating metals (SiO₂/Ag), metal oxides coating metal oxides (SiO₂/RuO₂), semiconductors coating semiconductors (Zns/CdSe) or combinations of all these materials.

In one embodiment, the particles comprise glass. The glasses can comprise low melting glasses with softening point below 500° C., below 400° C., or below 300° C. The glasses can comprise borosilicates, lead borosilicates, borosilicates comprising Al, Zn, Ag, Cu, In, Ba, Sr.

For example, the particles can comprise semiconducting metal oxides such as metal ruthenates. The metal oxide semiconductors can comprise ruthenium oxide, metal ruthenates comprising M-Ru—O with various ratios of M to Ru where M can be Bi, Sr, Pb, Cu, and other materials. The semiconducting materials can comprise metal nitrides that semiconduct.

The particles could include materials such as a semiconductor, a phosphor, an electrical conductor, a transparent electrical conductor, a thermochromic, an electrochromic, a magnetic material, a thermal conductor, an electrical insulator, a thermal insulator, a polishing compound, a catalyst, a pigment, or a drug or other pharmaceutical material.

In another aspect of the invention, the electronic ink comprises elemental carbon particles (micro- or nano-), such as in the form of graphite. Carbon is advantageous due to its very low cost and acceptable conductivity for many applications. In one embodiment, the electronic ink comprises one or more of particulate carbon, carbon black, modified carbon black, carbon nanotubes and/or carbon flakes. The inclusion of carbon in the electronic ink, optionally in combination with metallic particles and/or metallic precursors, is highly desirable for the formation of resistors.

Additionally or alternatively, the electronic ink comprises metallic nanoparticles, e.g., nanoparticles comprising a metallic composition, at least in part. Preferably, the metallic composition comprises a metal selected from the group consisting of silver, gold, copper, nickel, cobalt, palladium, platinum, indium, tin, zinc, titanium, chromium, tantalum, tungsten, iron, rhodium, iridium, ruthenium, osmium and lead. Of course, the ink optionally does not comprise metallic nanoparticles, or comprises less than about 0.1 weight percent metallic nanoparticles, based on the total weight of the electronic ink.

In other embodiments, the metallic composition comprises an alloy. The alloy may comprise a solid mixture, ordered or disordered, of 2, 3, 4 or more metals. In a preferred aspect, the alloy comprises at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium and lead. For example, the alloy optionally comprises a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold. In another aspect, the alloy comprises at least three metals.

If present, the metallic nanoparticles preferably comprise a metallic composition that exhibits a low bulk resistivity such as, e.g., a bulk resistivity of less than about 15 micro-Ω cm, e.g., less than about 10 micro-Ω cm, or less than about 5 micro-Ω cm.

Also, the nanoparticles may have a core-shell structure made of two different metals such as, e.g., a core of silver and a shell of nickel (e.g., a silver core having a diameter of about 20 nm surrounded by an about 15 nm thick nickel shell).

Metallic nanoparticles suitable for use in the present invention can be produced by a number of methods. A non-limiting example of such a method, commonly known as the polyol process, is disclosed in U.S. Pat. No. 4,539,041. A modification of this method is described in, e.g., P.-Y. Silvert et al., “Preparation of colloidal silver dispersions by the polyol process” Part 1—Synthesis and characterization, J. Mater. Chem., 1996, 6(4), 573-577; Part 2—Mechanism of particle formation, J. Mater. Chem., 1997, 7(2), 293-299. The entire disclosures of these documents are expressly incorporated by reference herein. Briefly, in the polyol process a metal compound is dissolved in, and reduced by a polyol such as, e.g., a glycol at elevated temperature to afford corresponding metal particles. In the modified polyol process the reduction is carried out in the presence of a dissolved polymer, e.g., polyvinylpyrrolidone.

A particularly preferred modification of the polyol process for producing metallic nanoparticles which carry an anti-agglomeration substance such as polyvinylpyrrolidone thereon is described in co-pending U.S. Provisional Application Ser. No. 60/643,378 entitled “Production of Metal Nanoparticles,” and in co-pending U.S. Provisional Application Ser. No. 60/643,629 entitled “Separation of Metal Nanoparticles,” both filed on Jan. 14, 2005. The entire disclosures of these co-pending applications are expressly incorporated by reference herein. In a preferred aspect of this modified process, a dissolved metal compound (e.g., a silver compound such as silver nitrate) is combined with and reduced by a polyol (e.g., ethylene glycol, propylene glycol and the like) at an elevated temperature (e.g., at about 120° C.) and in the presence of a heteroatom containing polymer (e.g., polyvinylpyrrolidone) which serves as anti-agglomeration substance.

According to a preferred aspect of the present invention, the metallic nanoparticles exhibit a narrow particle size distribution. A narrow particle size distribution is particularly advantageous for direct-write applications because it results in a reduced clogging of the orifice of a direct-write device by large particles and provides the ability to form features having a fine line width, high resolution and high packing density.

The metallic nanoparticles for use in the present invention preferably also show a high degree of uniformity in shape. Preferably, the metallic nanoparticles are substantially spherical in shape. Spherical particles are particularly advantageous because they are able to disperse more readily in a liquid suspension and impart advantageous flow characteristics to the electronic ink, particularly for deposition using an ink-jet device or similar tool. For a given level of solids loading, a low viscosity electronic ink having spherical particles will have a lower viscosity than a composition having non-spherical particles, such as flakes. Spherical particles are also less abrasive than jagged or plate-like particles, reducing the amount of abrasion and wear on the deposition tool.

In a preferred aspect of the present invention, at least about 90%, e.g., at least about 95%, or at least about 99% of the metallic nanoparticles comprised in the inks are substantially spherical in shape. In another preferred aspect, the electronic inks are substantially free of particles in the form of flakes.

In yet another preferred aspect, the particles are substantially free of micron-size particles, i.e., particles having a size of about 1 micron or above. Even more preferably, the nanoparticles may be substantially free of particles having a size (=largest dimension, e.g., diameter in the case of substantially spherical particles) of more than about 500 nm, e.g., of more than about 200 nm, or of more than about 100 nm. In this regard, it is to be understood that whenever the size and/or dimensions of the metallic nanoparticles are referred to herein and in the appended claims, this size and these dimensions refer to the nanoparticles without anti-agglomeration substance thereon, e.g., the metal cores of the nanoparticles. Depending on the type and amount of anti-agglomeration substance, an entire nanoparticle, i.e., a nanoparticle which has the anti-agglomeration substance thereon, may be significantly larger than the metal core thereof. Also, the term “nanoparticle” as used herein and in the appended claims encompasses particles having a size/largest dimension of the metal cores thereof of up to about 900 nm, preferably of up to about 500 nm, more preferably up to about 200 nm, or up to about 100 nm.

By way of non-limiting example, not more than about 5%, e.g., not more than about 2%, not more than about 1%, or not more than about 0.5% of the metallic nanoparticles may be particles whose largest dimension (and/or diameter) is larger than about 200 nm, e.g., larger than about 150 nm, or larger than about 100 nm. In a particularly preferred aspect, at least about 90%, e.g., at least about 95%, of the metallic nanoparticles will have a size of not larger than about 80 nm and/or at least about 80% of the metallic nanoparticles will have a size of from about 20 nm to about 70 nm. For example, at least about 90%, e.g., at least about 95% of the nanoparticles, may have a size of from about 30 nm to about 50 nm.

In another aspect, the metallic nanoparticles may have an average particle size (number average) of at least about 10 nm, e.g., at least about 20 nm, or at least about 30 nm, but preferably not higher than about 80 nm, e.g., not higher than about 70 nm, not higher than about 60 nm, or not higher than about 50 nm. For example, the metallic nanoparticles may have an average particle size in the range of from about 25 nm to about 75 nm.

In yet another aspect of the present invention, at least about 80 volume percent, e.g., at least about 90 volume percent of the metallic nanoparticles may be not larger than about 2 times, e.g., not larger than about 1.5 times the average particle size (volume average).

The nanoparticles that are useful in electronic inks according to the present invention preferably have a high degree of purity. For example, the particles (without anti-agglomeration substance) may include not more than about 1 atomic percent impurities, e.g., not more than about 0.1 atomic percent impurities, preferably not more than about 0.01 atomic percent impurities. Impurities are those materials that are not intended in the final product (e.g., the electronic feature) and that adversely affect the properties of the final product. For many electronic applications, the most critical impurities to avoid are Na, K, Cl, S and F.

In another aspect, the metallic nanoparticles can be coated with an intrinsically conductive polymer (which at the same time may serve as an anti-agglomeration substance), preventing agglomeration in the ink and providing a conductive path after solidification of the composition.

It is preferred for the total loading of metallic nanoparticles in the inks be not higher than about 75% by weight, such as from about 5% by weight to about 60% by weight, based on the total weight of the ink. Loadings in excess of the preferred amounts can lead to undesirably high viscosities and/or undesirable flow characteristics. Of course, the maximum loading which still affords useful results also depends on the density of the metal. In other words, the higher the density of the metal of the nanoparticles, the higher will be the acceptable and desirable loading in weight percent. In preferred aspects, the nanoparticle loading is at least about 10% by weight, e.g., at least about 15% by weight, at least about 20% by weight, or at least about 40% by weight. Depending on the metal, the loading will often not be higher than about 65% by weight, e.g., not higher than about 60% by weight. These percentages refer to the total weight of the nanoparticles, i.e., including any anti-agglomeration substance carried (e.g., adsorbed) thereon.

2. Metal Precursors

In one aspect, the electronic ink comprises one or more metal precursors. As used herein, the term “metal precursor” means a compound comprising a metal and capable of being converted (e.g., through a reaction with a reducing agent optionally with the application of heat) to form an elemental metal corresponding to the metal in the metal precursor. “Elemental metal” means a substantially pure metal or alloy having an oxidation state of 0. Examples of metal precursors include organometallics (molecules with carbon-metal bonds), metal organics (molecules containing organic ligands with metal bonds to other types of elements such as oxygen, nitrogen or sulfur) and inorganic compounds such as metal nitrates, metal halides and other metal salts. In several preferred aspects of the invention, the metal precursor comprises a metal nitrate (e.g., silver nitrate, copper nitrate or nickel nitrate) or a metal carboxylate (e.g., silver carboxylate, copper carboxylate or nickel carboxylate).

In a preferred embodiment, the metal in the metal precursor comprises one or more of silver (Ag), nickel (Ni), platinum (Pt), gold (Au), palladium (Pd), copper (Cu), ruthenium (Ru), indium (In) or tin (Sn), with silver being preferred for its high conductivity and copper being preferred for its good conductivity and low cost. In alternative embodiments, the metal in the metal precursor can include one or more of aluminum (Al), zinc (Zn), iron (Fe), tungsten (W), molybdenum (Mo), lead (Pb), bismuth (Bi), cobalt (Co) or similar metals. In a preferred embodiment, the metal precursor is soluble in one or more solvents in the electronic ink, although it is contemplated that the metal precursor may be insoluble in the electronic ink.

In another aspect, the metal precursor comprises a metal oxide, e.g., Ag₂O. In this embodiment, the electronic ink optionally is in the form a colloidal composition rather than a solution, the metal oxide being carried by a carrier medium. Such colloidal compositions may be well suited for direct write printing applications. When the metal oxide contacts a reducing agent (derived from the electronic ink or a secondary ink), the metal in the metal oxide is reduced to form the corresponding elemental metal.

In general, metal precursors that eliminate one or more ligands by a radical mechanism upon conversion to the elemental metal are preferred, especially if the intermediate species formed are stable radicals and therefore lower the decomposition temperature of that precursor compound.

Furthermore, metal precursors containing ligands that eliminate cleanly upon conversion and escape completely from the substrate (or the formed functional structure) are preferred because they are not susceptible to carbon contamination or contamination by anionic species such as nitrates. Therefore, preferred metal precursors for metals used for conductors include carboxylates, alkoxides or combinations thereof that would convert to metals, metal oxides or mixed metal oxides by eliminating small molecules such as carboxylic acid anhydrides, ethers or esters. Metal carboxylates, particularly halogenocarboxylates such as fluorocarboxylates, are particularly preferred metal precursors due to their high solubility.

3. Liquid Vehicles

As indicated above, the ink (or inks) used to form the electronic feature of the present invention preferably includes a liquid vehicle, which imparts flowability to the ink, optionally in combination with one or more other compositions. If the ink comprises nanoparticles, the vehicle preferably comprises a liquid that is capable of stably dispersing the nanoparticles, which optionally carry an anti-agglomeration substance thereon, e.g., are capable of affording a dispersion that can be kept at room temperature for several days or even one, two, three weeks or months or even longer without substantial agglomeration and/or settling of the nanoparticles. To this end, it is preferred for the vehicle and/or individual components thereof to be compatible with the surface of the nanoparticles, e.g., to be capable of interacting (e.g., electronically and/or sterically and/or by hydrogen bonding and/or dipole-dipole interaction, etc.) with the surface of the nanoparticles and in particular, with the anti-agglomeration substance.

It is particularly preferred for the vehicle to be capable of dissolving the optional anti-agglomeration substance to at least some extent, for example, in an amount (at 20° C.) of at least about 5 g of anti-agglomeration substance per liter of vehicle, particularly in an amount of at least about 10 g of anti-agglomeration substance, e.g., at least about 15 g, or at least about 20 g per liter of vehicle, preferably in an amount of at least about 100 g, or at least about 200 g per liter of vehicle. In this regard, it is to be appreciated that these preferred solubility values are merely a measure of the compatibility between the vehicle and the anti-agglomeration substance. They are not to be construed as indication that, in the inks, the vehicle is intended to actually dissolve the anti-agglomeration substance and remove it from the surface of the nanoparticles. On the contrary, the vehicle will usually not remove the anti-agglomeration substance from the surface of the nanoparticles to more than a minor extent, if at all.

In view of the preferred interaction between the vehicle and/or individual components thereof and the anti-agglomeration substance on the surface of the nanoparticles, the most advantageous vehicle and/or component thereof for the ink(s) is largely a function of the nature of the anti-agglomeration substance. For example, an anti-agglomeration substance which comprises one or more polar groups such as, e.g., a polymer like polyvinylpyrrolidone will advantageously be combined with a vehicle which comprises (or predominantly consists of) one or more polar components (solvents) such as, e.g., a protic solvent, whereas an anti-agglomeration substance which substantially lacks polar groups will preferably be combined with a vehicle which comprises, at least predominantly, aprotic, non-polar components.

Particularly if the ink(s) are intended for use in direct-write applications such as, e.g., ink-jet printing, the vehicle is preferably selected to also satisfy the requirements imposed by the direct-write method and tool such as, e.g., an ink-jet head, particularly in terms of viscosity and surface tension of the ink(s). These requirements are discussed in more detail further below. Another consideration in this regard is the compatibility of the nanoparticle composition with the substrate in terms of, e.g., wetting behavior (contact angle with the substrate).

As indicated above, if the ink comprises one or more metal precursors, the metal precursors preferably are soluble, at least partly, in the liquid vehicle, which in this case acts as a solvent.

In a preferred aspect, the vehicle in the ink(s) may comprise a mixture of at least two solvents, preferably at least two organic solvents, e.g., a mixture of at least three organic solvents, or at least four organic solvents. The use of more than one solvent is preferred because it allows, inter alia, to adjust various properties of a composition simultaneously (e.g., viscosity, surface tension, contact angle with intended substrate etc.) and to bring all of these properties as close to the optimum values as possible.

The solvents comprised in the vehicle may be polar or non-polar or a mixture of both, mainly depending on the nature of the anti-agglomeration substance. The solvents should preferably be miscible with each other to a significant extent. Non-limiting examples of solvents that are useful for the purposes of the present invention include alcohols, polyols, amines, amides, esters, acids, ketones, ethers, water, saturated hydrocarbons, and unsaturated hydrocarbons.

Particularly in the case of an anti-agglomeration substance, which comprises one or more heteroatoms available for hydrogen bonding, ionic interactions, etc. (such as, e.g., O and N), it is advantageous for the vehicle in the ink(s) to comprise one or more polar solvents and, in particular, protic solvents. For example, the vehicle may comprise a mixture of at least two protic solvents or at least three protic solvents. Non-limiting examples of such protic solvents include water, alcohols (e.g., aliphatic and cycloaliphatic alcohols having from 1 to about 12 carbon atoms such as, e.g., methanol, ethanol, n-propanol, isopropanol, 1-butanol, 2-butanol, sek.-butanol, tert.-butanol, the pentanols, the hexanols, the octanols, the decanols, the dodecanols, cyclopentanol, cyclohexanol, and the like), polyols (e.g., alkanepolyols having from 2 to about 12 carbon atoms and from 2 to about 4 hydroxy groups such as, e.g., ethylene glycol, propylene glycol, butylene glycol, 1,3-propanediol, 1,3-butanediol, 1,4-butanediol, 2-methyl-2,4-pentanediol, glycerol, trimethylolpropane, pentaerythritol, and the like), polyalkylene glycols (e.g., polyalkylene glycols comprising from about 2 to about 5 C₂₋₄ alkylene glycol units such as, e.g., diethylene glycol, triethylene glycol, tetraethylene glycol, dipropylene gycol, tripropylene glycol and the like) and partial ethers and esters of polyols and polyalkylene glycols (e.g., mono(C₁₋₆ alkyl) ethers and monoesters of the polyols and polyalkylene glycols with C₁₋₆ alkanecarboxylic acids, such as, e.g., ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether and diethylene glycol monobutyl ether (DEGBE), ethylene gycol monoacetate, diethylene glycol monoacetate, and the like). Additionally or alternatively, the vehicle comprises one or more hydrocarbons.

In one aspect, the liquid vehicle in the ink(s) comprises at least two solvents, e.g., at least three solvents, which solvents are preferably selected from C₂₋₄ alkanols, C₂₋₄ alkanediols and glycerol. For example, the vehicle may comprise ethanol, ethylene glycol and glycerol such as, e.g., from about 35% to about 45% by weight of ethylene glycol, from about 30% to about 40% by weight of ethanol and from about 20% to about 30% by weight of glycerol, based on the total weight of the vehicle. In a preferred aspect, the vehicle comprises about 40% by weight of ethylene glycol, about 35% by weight of ethanol and about 25% by weight of glycerol.

In another aspect, the liquid vehicle comprises a C₁₋₄ monoalkyl ether of a C₂₋₄ alkanediol and/or of a polyalkylene glycol.

In yet another aspect, the vehicle comprises not more than about 5 weight percent of water, e.g., not more than about 2 weight percent, or not more than about 1 weight percent of water, based on the total weight of the vehicle. For example, the vehicle may be substantially anhydrous.

Further non-limiting examples of organic solvents that may advantageously be used as the vehicle or a component thereof, respectively, include N,N-dimethylformamide, N,N-dimethylacetamide, ethanolamine, diethanolamine, triethanolamine, trihydroxymethylaminomethane, 2-(isopropylamino)-ethanol, 2-pyrrolidone, N-methylpyrrolidone, acetonitrile, the terpineols, ethylene diamine, benzyl alcohol, isodecanol, nitrobenzene and nitrotoluene.

As discussed in more detail below, when selecting a solvent combination for the liquid vehicle, it is desirable to also take into account the requirements, if any, imposed by the deposition tool (e.g., in terms of viscosity and surface tension of the ink) and the surface characteristics (e.g., hydrophilic or hydrophobic) of the intended substrate. In preferred inks, particularly those intended for ink-jet printing with a piezo head, the preferred viscosity thereof (measured at 20° C.) is not lower than about 5 cP, e.g., not lower than about 8 cP, or not lower than about 10 cP, and not higher than about 30 cP, e.g., not higher than about 20 cP, or not higher than about 15 cP. Preferably, the viscosity shows only small temperature dependence in the range of from about 20° C. to about 40° C., e.g., a temperature dependence of not more than about 0.4 cP/° C. It has surprisingly been found that in the case of preferred use in the present invention the presence of metallic nanoparticles in the liquid vehicle does not significantly change the viscosity of the vehicle, at least at relatively low loadings such as, e.g., up to about 20 weight percent. This may in part be due to the usually large difference in density between the vehicle and the nanoparticles which manifests itself in a much lower number of particles than the number of particles that the mere weight percentage thereof would suggest.

Further, the above preferred inks exhibit preferred surface tensions (measured at 20° C.) of not lower than about 20 dynes/cm, e.g., not lower than about 25 dynes/cm, or not lower than about 30 dynes/cm, and not higher than about 40 dynes/cm, e.g., not higher than about 35 dynes/cm. In one aspect, the ink has a surface tension ranging from about 25 dynes/cm to about 55 dynes/cm.

4. Anti-Agglomeration Agents

As indicated above, the electronic ink optionally comprises nanoparticulates. Due to their small size and the high surface energy associated therewith, nanoparticles usually show a strong tendency to agglomerate and form larger secondary particles (agglomerates). In one aspect of the invention, the nanoparticles comprise an anti-agglomerating agent, which inhibits agglomeration of the nanoparticles. Preferably, the nanoparticles are coated, at least in part, with the anti-agglomerating agent. The anti-agglomerating agent preferably comprises a polymer, preferably an organic polymer.

In several preferred embodiments, the polymer comprises a polymer of vinylpyrrolidone. More preferably, the polymer of vinylpyrrolidone comprises a homopolymer. In other aspects, the polymer of vinylpyrrolidone comprises a copolymer. The copolymer may be selected from the group consisting of a copolymer of vinylpyrrolidone and vinylacetate; a copolymer of vinylpyrrolidone and vinylimidazole; and a copolymer of vinylpyrrolidone and vinylcaprolactam.

The anti-agglomeration substance shields (e.g., sterically and/or through charge effects) the nanoparticles from each other to at least some extent and thereby substantially prevents a direct contact between individual nanoparticles. The anti-agglomeration substance is preferably adsorbed on the surface of the metallic nanoparticles. The term “adsorbed” as used herein includes any kind of interaction between the anti-agglomeration substance and a nanoparticle surface (e.g., the metal atoms on the surface of a nanoparticle) that manifests itself in an at least (and preferably) weak bond between the anti-agglomeration substance and the surface of a nanoparticle. Preferably, the bond is a non-covalent bond, but still strong enough for the nanoparticle/anti-agglomeration substance combination to withstand a washing operation with a solvent that is capable of dissolving the anti-agglomeration substance. In other words, merely washing the metallic nanoparticles with the solvent at room temperature will preferably not remove more than a minor amount (e.g., less than about 10%, less than about 5%, or less than about 1%) of the anti-agglomeration substance that is in intimate contact with (and (weakly) bonded to) the nanoparticle surface. Of course, any anti-agglomeration substance that is not in intimate contact with a nanoparticle surface but merely accompanies the bulk of the nanoparticles (e.g., as an impurity/contaminant), i.e., without any significant interaction therewith, will preferably be removable from the nanoparticles by washing the latter with a solvent for the anti-agglomeration substance.

The anti-agglomeration substance does not have to be present as a continuous coating (shell) on the entire surface of a metallic nanoparticle. Rather, in order to prevent a substantial agglomeration of the nanoparticles it will often be sufficient for the anti-agglomeration substance to be present on only a part of the surface of a metallic nanoparticle.

While the anti-agglomeration substance will usually be a single substance or at least comprise two or more substances of the same type, the present invention also contemplates the use of two or more different types of anti-agglomeration substances. For example, a mixture of two or more different low molecular weight compounds or a mixture of two or more different polymers may be used, as well as a mixture of one or more low molecular weight compounds and one or more polymers. The term “anti-agglomeration substance” as used herein includes all of these possibilities.

The weight ratio of metals (or alloys) in the metallic nanoparticles and anti-agglomeration substance(s) carried thereon can vary over a wide range. The most advantageous ratio depends, inter alia, on factors such as the nature of the anti-agglomeration substance (polymer, low molecular weight substance, etc.) and the size of the metal cores of the nanoparticles (the smaller the size the higher the total surface area thereof and the higher the amount of anti-agglomeration substance that will desirably be present). Usually, the weight ratio will be not higher than about 100:1, e.g., not higher than about 50:1, or not higher than about 30:1. On the other hand, the weight ratio will usually be not lower than about 5:1, e.g., not lower than about 10:1, not lower than about 15:1, or not lower than about 20:1.

5. Reducing Agents

In one embodiment of the present invention, the electronic ink further comprises a reducing agent. The reducing agent may be selected from one or more compounds that are capable of being oxidized and hence that are capable of reducing a metal precursor to its corresponding elemental metal. In other aspects, the reducing agent may be used to convert one or more other types of precursors, e.g., substrate precursors, dielectric precursors, semiconductor precursors, etc., to their desired final form.

In a preferred embodiment, the reducing agent is selected from the group consisting of alcohols, aldehydes, amines, amides, alanes, boranes, borohydrides, aluminohydrides and organosilanes. More preferably, the reducing agent is selected from the group consisting of alcohols, amines, amides, boranes, borohydrides and organosilanes. A non-limiting exemplary list of reducing agents that may be implemented according to the present invention is provided below in Table 1.

TABLE 1
EXEMPLARY REDUCING AGENTS

| MATERIALS | SPECIFIC EXAMPLES |
|---|---|
| Amines | Triethyl amine; Amino |
| | propanol |
| Boranes | Borane-tetrahydrofuran |
| Borane adducts | Trimethylaminoborane |
| Borohydrides | Sodium borohydride, lithium |
| | borohydride |
| Hydrides | Tin hydride, lithium hydride, |
| | lithium aluminum hydride, |
| | sodium borohydride |
| Alcohols | Methanol, ethanol, |
| | isopropanol, terpineol, t- |
| | butanol, ethylene glycols, |
| | citrates, other polyols |
| Silanes | Dichlorosilane |
| Carboxylic acid | Formic acid |
| Aldehyde | Formaldehyde; octanal, |
| | decanal, dodecanal, glucose |
| Hydrazines | Hydrazine, hydrazine sulfate |
| Amides | Dimethylformamide |
| Phosphorous compounds | Hypophosphoric Acid |

Table 2 shows non-limiting examples of some preferred combinations of reducing agents and metal precursors that may be included in the present invention.

TABLE 2
EXEMPLARY METAL PRECURSOR/REDUCING
AGENT COMBINATIONS

| METAL PRECURSOR | REDUCING AGENT |
|---|---|
| Most Metal Nitrates | Amines (e.g., triethylamine), |
| | ethylene glycols, alcohols |
| | (terpineol), aminopropanol |
| Copper Nitrate | Long chain alcohols; citrates, |
| | carboxylates |
| Most Metal Carboxylates | Amines (e.g., triethylamine), |
| | ethylene glycols, alcohols |
| | (terpineol), aminopropanol |

Additionally or alternatively, the reducing agent can also be part of the metal precursor, discussed above, for example in the case of certain ligands. An example is Cu-formate where the precursor forms copper metal even in ambient air at low temperatures. In addition, the Cu-formate precursor is highly soluble in water, results in a relatively high metallic yield and forms only gaseous byproducts, which are reducing in nature and protect the in-situ formed copper from oxidation. Cu-formate is therefore a preferred copper precursor for aqueous based precursor compositions. Other examples of metal precursors containing a ligand that is a reducing agent are Ni-acetylacetonate and Ni-formate.

The electronic ink optionally comprises the reducing agent in an amount from about 1 to about 50 weight percent, e.g., from about 5 to about 40 weight percent or from about 20 to about 30 weight percent, based on the total weight of the electronic ink.

6. Additives

The inks used to form the electronic features of the present invention also may include one or more additives. Non-limiting examples of such additives will be discussed below. It should be taken into account that additives will in many cases have an adverse effect on the conductivity of the final material, in particular, if they can be removed from the material only with difficulty (e.g., by decomposition with the application of high temperatures) or not at all. Therefore it will usually be desirable to keep the amount of conductivity-impairing additives at a minimum.

The inks used to form the electronic features can include rheology modifiers. Non-limiting examples of rheology modifiers that are suitable for use in the present invention include SOLTHIX 250 (Avecia Limited), SOLSPERSE 21000 (Avecia Limited), styrene allyl alcohol (SAA), ethyl cellulose, carboxy methylcellulose, nitrocellulose, polyalkylene carbonates, ethyl nitrocellulose, and the like. These additives can reduce spreading of the inks after deposition, as discussed in more detail below.

The ink or inks optionally further include additives such as, e.g., wetting angle modifiers, humectants, crystallization inhibitors and the like. Of particular interest are crystallization inhibitors as they prevent crystallization and the associated increase in surface roughness and film uniformity during curing at elevated temperatures and/or over extended periods of time.

Although the ink or inks may include one or more metal precursors as disclosed in, e.g., published U.S. Patent Application Nos. 2003/0148024 A1 and 2003/0180451 A1, the entire disclosures of which are expressly incorporated by reference herein, it is preferred that the ink(s) be substantially free of such metal precursor compounds.

Also, the inks preferably do not comprise added binder, e.g., polymeric binder. In this regard it is to be noted that, in the case of polymeric anti-agglomeration substances such as, e.g., polyvinylpyrrolidone, the anti-agglomeration substance itself may serve as a binder, as explained in more detail below.

Electronic inks intended for use in an ink-jet device may also include surfactants to maintain the particles in suspension. Co-solvents, also known as humectants, can be used to prevent the electronic ink from crusting and clogging the orifice of the ink-jet head. Biocides can also be added to prevent bacterial growth over time. Non-limiting examples of corresponding ink-jet liquid vehicle compositions are disclosed in, e.g., U.S. Pat. Nos. 5,853,470; 5,679,724; 5,725,647; 4,877,451; 5,837,045 and 5,837,041, the entire disclosures whereof are incorporated by reference herein. The selection of such additives is based upon the desired properties of the composition, as is known to those skilled in the art. As set forth above, care should be taken that the additives of the composition do not have a significant adverse effect on the conductivity of the final feature and/or can be removed easily.

B. Processes for Forming Electronic Features from Electronic Inks

Many processes are known for forming electronic features from the above-described electronic inks. The processes can generally be divided between: (1) processes that involve a chemical reaction in which a precursor is converted to a component in the electronic feature; and (2) processes in which no chemical reaction is involved. In one embodiment of the latter type of process, at least a portion of the electronic feature is formed by a process comprising the steps of: (a) depositing an electronic ink (optionally comprising nanoparticles, e.g., metallic and/or non-metallic nanoparticles) and a liquid vehicle onto a substrate surface; and (b) removing the liquid vehicle, e.g., by heating, under conditions effective to form the at least a portion of the electronic feature. In various embodiments, the ink comprises one or more of the following components: metallic nanoparticles, a metal precursor, a reducing agent, an anti-agglomeration agent, additives, and/or other components and a liquid vehicle. In one aspect, step (b) comprises heating the deposited ink under conditions effective to remove the majority of the liquid vehicle, and optionally sinter adjacent metallic nanoparticles to one another to form at least a portion of the electronic feature.

In one embodiment in which a chemical reaction is involved, at least a portion of the electronic feature is formed by a process comprising the steps of: (a) depositing an electronic ink comprising a precursor (e.g., a metal precursor) and a liquid vehicle onto a substrate surface; and (b) reacting the precursor with a reducing agent under conditions effective to form the at least a portion of the electronic feature. In another embodiment, the substrate comprises a pre-printed layer of cationic polymer, which reacts with the deposited electronic ink to form the electronic feature.

The electronic inks can be deposited onto surfaces using a variety of tools such as, e.g., low viscosity deposition tools. As used herein, a low viscosity deposition tool is a device that deposits a liquid or liquid suspension onto a surface by ejecting the ink through an orifice toward the surface without the tool being in direct contact with the surface. The low viscosity deposition tool is preferably controllable over an x-y grid, referred to herein as a direct-write deposition tool. A preferred direct-write deposition tool according to the present invention is an ink-jet device. Other examples of direct-write deposition tools include aerosol jets and automated syringes, such as the MICROPEN tool, available from Ohmcraft, Inc., of Honeoye Falls, N.Y.

A preferred direct-write deposition tool for the purposes of the present invention is an ink-jet device. Ink-jet devices operate by generating droplets of the composition and directing the droplets toward a surface. The position of the ink-jet head is carefully controlled and can be highly automated so that discrete patterns of the composition can be applied to the surface. Ink-jet printers are capable of printing at a rate of about 1000 drops per jet per second or higher and can print linear features with good resolution at a rate of about 10 cm/sec or more, up to about 1000 cm/sec. Each drop generated by the ink-jet head includes approximately 3 to about 100 picoliters of the composition, which is delivered to the surface. For these and other reasons, ink-jet devices are a highly desirable means for depositing materials onto a surface.

Typically, an ink-jet device includes an ink-jet head with one or more orifices having a diameter of not greater than about 100 μm, such as from about 50 μm to about 75 μm. Droplets are generated and are directed through the orifice toward the surface being printed. Ink-jet printers typically utilize a piezoelectric driven system to generate the droplets, although other variations are also used. Ink-jet devices are described in more detail in, for example, U.S. Pat. Nos. 4,627,875 and 5,329,293, the disclosures whereof are incorporated by reference herein in their entireties.

It is also expedient to simultaneously control the surface tension and the viscosity of the electronic ink to enable the use of industrial ink-jet devices. Preferably the surface tension is from about 10 to about 50 dynes/cm, such as from about 20 to about 40 dynes/cm, while the viscosity is maintained at a value of not greater than about 50 centipoise.

According to one aspect, the solids loading of particles in the electronic ink is preferably as high as possible without adversely affecting the viscosity or other desired properties of the composition. As set forth above, a electronic ink preferably has a particle loading of not higher than about 75 weight percent, e.g., from about 5 to about 50 weight percent.

The electronic inks can also be deposited by aerosol jet deposition. Aerosol jet deposition allows the formation of electronic features having a feature width of, e.g., not greater than about 200 μm, such as not greater than about 150 μm, not greater than about 100 μm and even not greater than about 50 μm. In aerosol jet deposition, the electronic ink is aerosolized into droplets and the droplets are transported to the substrate in a flow gas through a flow channel. Typically, the flow channel is straight and relatively short. Examples of tools and methods for the deposition of fluids using aerosol jet deposition include those disclosed in U.S. Pat. Nos. 6,251,488; 5,725,672 and 4,019,188, the entire disclosures whereof are incorporated by reference herein.

The electronic inks of the present invention can also be deposited by a variety of other techniques including intaglio, roll printer, spraying, dip coating, spin coating, and other techniques that direct discrete units of fluid or continuous jets, or continuous sheets of fluid to a surface. Other examples of advantageous printing methods for the compositions of the present invention include lithographic printing and gravure printing. For example, gravure printing can be used with electronic inks having a viscosity of up to about 5,000 centipoise. The gravure method can deposit features having an average thickness of from about 1 μm to about 25 μm and can deposit such features at a high rate of speed, such as up to about 700 meters per minute. The gravure process also comprises the direct formation of patterns onto the surface.

As discussed above, the deposition of a electronic ink according to the present invention can be carried out, for example, by pen/syringe, continuous or drop on demand ink-jet, droplet deposition, spraying, flexographic printing, lithographic printing, gravure printing, other intaglio printing, and others. The electronic ink can also be deposited by dip-coating or spin-coating, or by pen dispensing onto rod or fiber type substrates. Immediately after deposition, the composition may spread, draw in upon itself, or form patterns depending on the surface modification discussed above. In another aspect, a method is provided for processing the deposited composition using two or more jets or other ink sources. An example of a method for processing the deposited composition is using infiltration into a porous bed formed by a previous fabrication method. Another exemplary method for depositing the composition is using multi-pass deposition to build the thickness of the deposit. Another example of a method for depositing the composition is using a heated head to decrease the viscosity of the composition.

The properties of the deposited electronic ink can also be subsequently modified. This can include freezing, melting and otherwise modifying the properties such as viscosity with or without chemical reactions or removal of material from the electronic ink. For example, a electronic ink including a UV-curable polymer can be deposited and immediately exposed to an ultraviolet lamp to polymerize and thicken and reduce spreading of the composition. Similarly, a thermoset polymer can be deposited and exposed to a heat lamp or other infrared light source.

After deposition, the electronic ink may be treated to convert the electronic ink to the desired structure and/or material, e.g., an electronic feature. The treatment can include multiple steps, or can occur in a single step, such as when the electronic ink is rapidly heated and held at the processing temperature for a sufficient amount of time to form an electronic feature.

An optional, initial step may include drying or subliming of the composition by heating or irradiating. In this step, material (e.g., solvent) is removed from the composition and/or chemical reactions occur in the composition. Non-limiting examples of methods for processing the deposited composition in this manner include methods using a UV, IR, laser or a conventional light source. Heating rates for drying the electronic ink are preferably greater than about 10° C./min, more preferably greater than about 100° C./min and even more preferably greater than about 1000° C./min. The temperature of the deposited electronic ink can be raised using hot gas or by contact with a heated substrate. This temperature increase may result in further evaporation of vehicle and other species. A laser, such as an IR laser, can also be used for heating. An IR lamp, a hot plate or a belt furnace can also be utilized. It may also be desirable to control the cooling rate of the deposited feature.

The electronic inks can be processed for very short times and still provide useful materials. Short heating times can advantageously prevent damage to the underlying substrate. For example, thermal processing times for deposits having a thickness on the order of about 10 μm may be not greater than about 100 milliseconds, e.g., not greater than about 10 milliseconds, or not greater than about 1 millisecond. The short heating times can be provided using laser (pulsed or continuous wave), lamps, or other radiation. Particularly preferred are scanning lasers with controlled dwell times. When processing with belt and box furnaces or lamps, the hold time may often be not longer than about 60 seconds, e.g., not longer than about 30 seconds, or not longer than about 10 seconds. The heating time may even be not greater than about 1 second when processed with these heat sources, and even not greater than about 0.1 second while still providing conductive materials that are useful in a variety of applications. The preferred heating time and temperature will also depend on the nature of the desired feature, e.g., of the desired electronic feature. It will be appreciated that short heating times may not be beneficial if the solvent or other constituents boil rapidly and form porosity or other defects in the feature.

By way of non-limiting example, a electronic feature in accordance with the present invention may be cured by a number of different methods including thermal, UV and pressure-based curing. The thermal curing can be effected by removing the solvents at low temperatures and creating a reflective print. On some substrates such as paper, no thermal curing step may be necessary at all, while in others a mild thermal curing step such as short exposure to an IR lamp may be sufficient. In this particular embodiment, the electronic ink has a higher absorption cross-section for the IR energy derived from the lamp than the surrounding substrate and so the printed metallic feature is preferentially thermally cured.

In cases where the ink contains a photoactive reagent a printed metallic feature in accordance with the present invention may also be cured by irradiation with UV light. The photoactive reagent may, for example, be a monomer or low molecular weight polymer which polymerizes on exposure to UV light resulting in a robust, insoluble metallic layer. In cases where electric conductivity is important, a photoactive metal species may, for example, be incorporated into the ink to provide good connectivity between the nanoparticles in the ink after curing. In this embodiment, the photoactive metal-containing species is photochemically reduced to form the corresponding metal.

In a further aspect of the present invention, the printed electronic ink may be cured by compression. This can be achieved by exposing the substrate containing the printed feature to any of a variety of different processes that “weld” the nanoparticles in the ink. Non-limiting examples of these processes include stamping and roll pressing. For example, for applications in the security industry, subsequent processing steps in the construction of a secure document are likely to include intaglio printing which will result in the exposure of the substrate containing the printed metallic feature to high pressure and temperatures in the range of from about 50° C. to about 100° C. The temperature or the pressure or both combined will usually be sufficient to cure the electronic ink and create a reflective and/or electrical conductor. Of course, any combination of heating, pressing and UV-curing may be used for curing a printed feature in accordance with the present invention.

In one aspect of the present invention, the deposited electronic ink may be converted to an electronic feature at temperatures of not higher than about 300° C., e.g., not higher than about 250° C., not higher than about 225° C., not higher than about 200° C., or even not higher than about 185° C. In many cases it will be possible to achieve substantial conductivity at temperatures of not higher than about 150° C., e.g., at temperatures of not higher than about 125° C., or even at temperatures of not higher than about 100° C. Any suitable method and device and combinations thereof can be used for the conversion, e.g., heating in a furnace or on a hot plate, irradiation with a light source (UV lamp, IR or heat lamp, laser, etc.), combinations of any of these methods, to name just a few.

On some substrates such as paper, no thermal curing step may be necessary, while in others a mild thermal curing step such as, e.g., short exposure to an infra-red lamp may be sufficient. In this particular embodiment, the electronic ink may have a higher absorption cross-section for the IR energy derived from the heat lamp compared to the surrounding substrate and so the applied composition may be preferentially thermally cured.

High conductivities may be achieved, if desired, by heating to relatively low temperatures. By way of non-limiting example, after heating to a temperature of about 200° C., or even to a temperature of about 150° C., a deposited composition of the present invention may show a resistivity which is not higher than about 30 times, e.g., not higher than about 20 times, not higher than about 10 times, not higher than about 5 times, or not higher than about 3 times the resistivity of the pure bulk metal or metallic phase (e.g., alloy).

If present, the particles in the electronic ink may optionally be (fully) sintered. The sintering can be carried out using, for example, furnaces, light sources such as heat lamps and/or lasers. In one aspect, the use of a laser advantageously provides very short sintering times and in one aspect the sintering time is not greater than about 1 second, e.g., not greater than about 0.1 seconds, or even not greater than about 0.01 seconds. Laser types include pulsed and continuous wave lasers. In one aspect, the laser pulse length is tailored to provide a depth of heating that is equal to the thickness of the material to be sintered.

It will be appreciated from the foregoing discussion that two or more of the latter process steps (drying, heating and sintering) can be combined into a single process step. Also, one or more of these steps may optionally be carried out in a reducing atmosphere (e.g., in an H₂/N₂ atmosphere for metals that are prone to undergo oxidation, especially at elevated temperature, such as e.g., Ni) or in an oxidizing atmosphere.

The deposited and treated material, e.g., the electronic feature of the present invention, may be post-treated. The post-treatment can, for example, include cleaning and/or encapsulation of the electronic feature (e.g., in order to protect the deposited material from oxygen, water or other potentially harmful substances) or other modifications. The same applies to any other metal structures that may be formed (e.g., deposited) with a nanoparticle composition of the present invention.

One exemplary process flow includes the steps of: forming a structure by conventional methods such as lithographic, gravure, flexo, screen printing, photo patterning, thin film or wet subtractive approaches; identifying locations requiring addition of material; adding material by a direct deposition of a low viscosity composition; and processing to form the final product. In a specific aspect, a circuit may be prepared by, for example, screen-printing and then be repaired by localized printing of a low viscosity electronic ink of the present invention.

In another aspect, features larger than approximately 100 μm are first prepared by screen-printing. Features not greater than about 100 μm are then deposited by a direct deposition method using a electronic ink.

In one embodiment, the electronic feature of the present invention has a resistivity that is not greater than about 20 times the bulk resistivity of the pure metal/alloy, e.g., not greater than about 10 times the bulk resistivity, not greater than about 5 times the bulk resistivity, or even not greater than about 2 times the bulk resistivity of the pure metal/alloy.

In accordance with the direct-write processes, the present invention comprises the formation of features for devices and components having a small minimum feature size. For example, the method of the present invention can be used to fabricate features having a minimum feature size (the smallest feature dimension in the x-y axis) of not greater than about 200 μm, e.g., not greater than about 150 μm, or not greater than about 100 μm. These feature sizes can be provided using ink-jet printing and other printing approaches that provide droplets or discrete units of composition to a surface. The small feature sizes can advantageously be applied to various components and devices, as is discussed below.

The inks can be used to form dots, squares and other isolated regions of material. The regions (and optionally the corresponding electronic features) can have a minimum feature size of not greater than about 250 μm, such as not greater than about 100 μm, and even not greater than about 50 μm, such as not greater than about 25 μm, or potentially not greater than about 10 μm. These features can be deposited by ink-jet printing of a single droplet or multiple droplets at the same location with or without drying in between deposition of droplets or periods of multiple droplet deposition. In one aspect, the surface tension of the electronic ink on the substrate material may be chosen to provide poor wetting (e.g., poor penetration) of the surface so that the composition contracts onto itself after printing. This provides a method for producing deposits with sizes equal to or smaller than the droplet diameter.

The applied composition (e.g., the electronic feature) may also be cured by irradiation with UV light where the ink contains a photoreactive reagent. The photoreactive reagent may, for example, be a monomer or low molecular weight polymer which polymerizes on exposure to UV light resulting in a robust, insoluble metallic layer. In cases where electronic conductivity is important, a photoreactive metal species may be incorporated into the ink to provide good connectivity between the nanoparticles in the ink after curing. In this particular embodiment, the photoactive metal-containing species is photochemically reduced to form the corresponding metal.

After the electronic ink is printed on the substrate, it may be heated to yield the desired electrical performance, adhesion, and abrasion resistance. This heating can be accomplished in a variety of ways such as hot plate, convection oven, infrared radiation, laser radiation, UV exposure, etc. In general, the resistivity of a printed structure will drop with curing temperature and curing time. In one aspect, the detailed time-temperature profile may play a role in the final electrical performance of the printed line or feature: by way of non-limiting example, drying the ink at about 80° C. before heating it to about 120° C. may in some cases result in a feature with a significantly lower conductivity than that of a feature that was printed and immediately heated to about 120° C. without allowing it to dry.

The electrical performance of a cured printed line is often described in terms of the bulk resistivity of the cured line. These values are obtained by measuring the resistance (R) of the printed line, the length (l), and the average cross sectional area (width times thickness: wd). The bulk resistivity (ρ) is calculated using the equation: ρ (Ω cm)=R(Ω)×wd/l (cm). The most accurate data are obtained when using the ratiometric resistance measurement procedure which eliminates contact resistance. When adequate sensing probes are used that do not damage the printed metal, in combination with printed contact pads, a two-point probe measurement can also be used to provide reliable data.

In a preferred aspect of the present invention the peak curing temperature and the curing time are the main factors that determine the ultimate electrical performance of the printed metals. In addition, secondary parameters such as heating profile (ramp rate, drying or no drying prior to heating), substrate type (e.g., coated paper, PET, glass, etc.) curing ambient, and heating method (e.g., oven, laser, IR, etc.) may also play a role.

If desired, high conductivity can be achieved after very short curing times at temperatures above about 200° C. For example, a 60 second cure at 300° C. may yield a printed Ag line with a bulk resistivity value of about 3.8 μΩ cm. In another example, high electrical conductivity can be accomplished with curing times in the single digit second range at temperatures of from about 250° C. to about 550° C. Curing processes such as in-line RTP (rapid thermal processing) can be used to cure the printed features after printing and achieve the desired electrical properties. This will enable a significant reduction in tact time in a manufacturing process when compared to competing materials and processes.

C. Substrates

Preferred inks according to the present invention can be deposited and converted to electronic features at low temperatures, thereby enabling the use of a variety of substrates having a relatively low softening (melting) or decomposition temperature.

Non-limiting examples of substrates that are particularly advantageous according to the present invention include substrates comprising one or more of fluorinated polymer, polyimide, epoxy resin (including glass-filled epoxy resin), polycarbonate, polyester, polyethylene, polypropylene, polyvinyl chloride, ABS copolymer, synthetic paper, flexible fiberboard, non-woven polymeric fabric, cloth and other textiles. Other particularly advantageous substrates include cellulose-based materials such as wood or paper, and metallic foil and glass (e.g., thin glass). The substrate may be coated. Although the inks can be used particularly advantageously for temperature-sensitive substrates, it is to be appreciated that other substrates such as, e.g., metallic and ceramic substrates can also be used in accordance with the present invention.

Of particular interest for display applications are glass substrates and ITO coated glass substrates. Other glass coatings that the metal features may be printed on in flat panel display applications include semiconductors such as c-Si on glass, amorphous Si on glass, poly-Si on glass, and organic conductors and semiconductors printed on glass. The glass may also be substituted with, e.g., a flexible organic transparent substrate such as PET or PEN. The metal or alloy (e.g., Ag) may also be printed on top of a black layer or coated with a black layer to improve the contrast of a display device. Other substrates of particular interest include printed circuit board substrates such as FR4, textiles including woven and non-woven textiles.

Another substrate of particular interest is natural or synthetic paper, in particular, paper that has been coated with specific layers to enhance gloss and accelerate the infiltration of ink solvent or liquid vehicle. A preferred example of a glossy coating for ink-jet paper includes alumina nanoparticles such as fumed alumina or silica as well as precipitated alumina or silica in a binder. Also, a silver ink according to the present invention that is ink-jet printed on EPSON glossy photo paper and heated for about 30 min at about 100° C. is capable of exhibiting highly conductive Ag metal lines with a bulk conductivity in the 10 micro-Ω cm range.

According to a preferred aspect of the present invention, the substrate onto which the electronic ink is deposited may have a softening and/or decomposition temperature of not higher than about 225° C., e.g., not higher than about 200° C., not higher than about 185° C., not higher than about 150° C., or not higher than about 125° C.

D. Exemplary Electronic Features

The electronic features ultimately formed from the electronic inks according to the processes of the present invention may vary widely. For example, the electronic feature may comprise a passive feature such as a conductor, a resistor, a dielectric, an inductor, a ferromagnetic, or a capacitor. In other aspects, the electronic feature comprises an active feature such as a transistor, a sensor, a display device, or a memory device (e.g., a ROM device).

In one aspect, the electronic features optionally are in the form of lines. In one aspect, the lines can advantageously have an average width of not greater than about 250 μm, such as not greater than about 200 μm, not greater than about 150 μm, not greater than about 100 μm, or not greater than about 50 μm.

The electronic features optionally are transparent, semi-transparent and/or reflective in the visible light range and/or in any other range such as, e.g., in the UV and/or IR ranges. (The terms “feature” and “structure” as used herein and in the appended claims include any two- or three-dimensional structure including, but not limited to, a line, a dot, a patch, a continuous or discontinuous layer (e.g., coating) and in particular, any electronic feature that is capable of being formed on any substrate.) In particular, the electronic features may be used in RFID antennas and tags, digitally printed multi-layer circuit boards, printed membrane keyboards, smart packages, security documents, “disposable electronics” printed on plastics or paper stock, interconnects for applications in printed logic, passive matrix displays, and active matrix backplanes for applications such as OLED displays and TFT AMLCD technology.

As indicated above, the electronic feature optionally is used in or as an antenna for RF (radio frequency) tags and smart cards. The electronic feature can also serve as a solder replacement. Such compositions can include silver, lead or tin.

In one aspect, the surface to be printed onto is not planar and a non-contact (indirect) printing approach is used. The non-contact printing approach can be ink-jet printing or another technique providing deposition of discrete units of fluid onto the surface. Examples of surfaces that are non-planar include in windshields, electronic components, electronic packaging and visors.

In other aspects, the electronic features may be used in flat panel displays, such as plasma display panels. Ink-jet deposition of metal powders-based inks is a particularly useful method for forming the electrodes for a plasma display panel. The inks and methods can advantageously be used to form the electrodes, as well as the bus lines and barrier ribs, for the plasma display panel. Typically, a metal paste is printed onto a glass substrate and is fired in air at from about 450° C. to about 600° C. Direct-write deposition of electronic inks offers many advantages over paste techniques including faster production time and the flexibility to produce prototypes and low-volume production applications. The deposited features will have high resolution and dimensional stability, and will have a high density.

The present invention is also applicable to inductor-based devices including transformers, power converters and phase shifters. Examples of such devices are illustrated in, e.g., U.S. Pat. Nos. 5,312,674; 5,604,673 and 5,828,271, the entire disclosures whereof are incorporated by reference herein.

The present invention can also be used to fabricate antennas such as antennas used for cellular telephones. The design of antennas typically involves many trial and error iterations to arrive at the optimum design. The direct-write process of the present invention advantageously permits the formation of antenna prototypes in a rapid and efficient manner, thereby reducing a product development time. Examples of microstrip antennas are illustrated in, e.g., U.S. Pat. Nos. 5,121,127; 5,444,453; 5,767,810 and 5,781,158, the entire disclosures whereof are incorporated herein by reference. The methodology of the present invention can be used to form the conductors of an antenna assembly.

Additional applications of the inks and methods of the present invention include low cost or disposable electronic devices such as electronic displays, electrochromic, electrophoretic and light-emitting polymer-based displays. Other applications include circuits embedded in a wide variety of devices such as low cost or disposable light-emitting diodes, solar cells, portable computers, pagers, cell phones and a wide variety of internet compatible devices such as personal organizers and web-enabled cellular phones.

The electrical features of the present invention optionally comprises a conductive pattern that can be used in a flat panel display. The compositions according to the present invention allow the direct deposition of metal electrodes onto low temperature substrates such as plastics. For example, a silver electronic ink can be ink-jet printed and heated at 150° C. to form 150 μm by 150 μm square electrodes with good adhesion and sheet resistivity values.

In one aspect, the electronic inks of the present invention may be used to interconnect electrical elements on a substrate, such as non-linear elements.

In another aspect, the present invention relates to electrical interconnects and electrodes for liquid crystal displays (LCDs), including passive-matrix and active-matrix. Particular examples of LCDs include twisted nematic (TN), supertwisted nematic (STN), double supertwisted nematic (DSTN), retardation film supertwisted nematic (RFSTN), ferroelectric (FLCD), guest-host (GHLCD), polymer-dispersed (PD), polymer network (PN).

The present invention also comprises a wide variety of security and authentication applications, such as, for example, coupon redemption, inventory security, currency security, compact disk security and driver's license and passport security. The present invention can also be utilized as an effective alternative to magnetic strips. Presently, magnetic strips include identification numbers such as credit card numbers that are programmed at the manufacturer. These strips are prone to failure and are subject to fraud because they are easily copied or modified. To overcome these shortcomings, circuits can be printed on the substrate and encoded with specific consumer information. Thus, the present invention can be used to improve the security of credit cards, ATM cards and any other tracking card, which uses magnetic strips as a security measure.

### III. PROCESSES FOR CONTROLLING INK MIGRATION DURING THE FORMATION OF PRINTABLE ELECTRONIC FEATURES

As indicated above, a difficulty that may be encountered in the printing and processing of low viscosity electronic inks is that the inks can wet the surface and rapidly spread, increasing the width of the deposit and thereby negating the advantages of fine line printing. This is particularly true when ink-jet printing is employed to deposit fine features such as interconnects, because ink-jet technology puts relatively strict upper boundaries on the viscosity of the inks that can be employed.

According to a preferred aspect of the present invention, the inks can be confined on the substrate, thereby enabling the formation of features having a small minimum feature size, the minimum feature size being the smallest dimension in the x-y axis, such as the width of a conductive line. The preferred inks can be confined to regions having a width of not greater than about 200 μm, preferably not greater than about 150 μm, e.g., not greater than about 100 μm, or not greater than about 50 μm.

In a preferred aspect, the invention is to a process, which comprises the steps of: (a) providing a first substrate having a first surface; (b) modifying the first surface to form a modified surface; and (c) applying an ink (which optionally comprises nanoparticles) to at least a portion of the modified surface, wherein the modified surface interacts with the ink to inhibit one or both lateral migration and/or longitudinal migration of the applied ink (relative to the first surface) and wherein the applied ink forms at least a portion of the electronic feature. In a preferred aspect, the first surface has a first surface energy and the modified surface has a second surface energy, which is greater than the first surface energy. In an alternative embodiment, the second surface energy is less than the first surface energy.

The modification of the first surface to form the modified surface may be achieved by a variety of modification techniques. A non-limiting list of examples of steps for modifying the first surface includes: (1) providing a physical barrier composition to limit either or both longitudinal ink migration and/or lateral ink migration; (2) modifying substrate surface energy; (3) applying an adhesion promoter to a substrate; (4) forming a region having an opposite charge relative to the ink to be applied; and (5) selectively providing regions of increased or decreased porosity (in number and/or size) relative to the unmodified substrate. In another embodiment, the invention is to a process for encouraging electronic ink spreading with a surfactant.

A. Inhibiting Ink Migration with a Barrier Composition

As indicated above, in one embodiment, either or both lateral and/or longitudinal ink migration is inhibited by forming one or more barrier compositions on a substrate. In this embodiment, the physical barrier composition may be formed by an additive process or a subtractive process. In either embodiment, the barrier composition preferably is formed from a barrier medium or ink, which may or may not be applied to the substrate in the form of a barrier layer.

In the additive process, one or more physical barrier compositions are formed on a substrate prior to application of the electronic ink. The barrier compositions may be formed through a variety of techniques. Retaining barriers and patches can be deposited to confine the flow of an ink within a certain region. For example, a photoresist layer can be spin coated on a polymer substrate. Photolithography can be used to form trenches and other patterns in the photoresist layer. These patterns can be used to retain the ink or inks that are deposited onto these preformed patterns. After drying, the photolithographic mask may or may not be removed with the appropriate solvents without removing the deposited metal. Retaining barriers can also be deposited with direct-write deposition approaches such as ink-jet printing or any other direct-write approach, as disclosed herein.

For example, a polymer trench can be ink-jet printed onto a flat substrate by depositing two parallel lines with narrow parallel spacing. An electronic ink, as described above, can be printed between the two parallel lines, which confine the ink. Of course, the applied barrier ink need not be in the form of parallel lines, and other confining designs may be easily designed based on the specifically desired confining arrangement. Another group of physical barriers includes printed lines or features with a certain level of porosity that can retain a low viscosity ink by capillary forces. The confinement layer may comprise particles applied by any of the techniques disclosed herein. The particles confine the ink that is deposited onto the particles to the spaces between the particles because of wetting of the particles by the electronic ink.

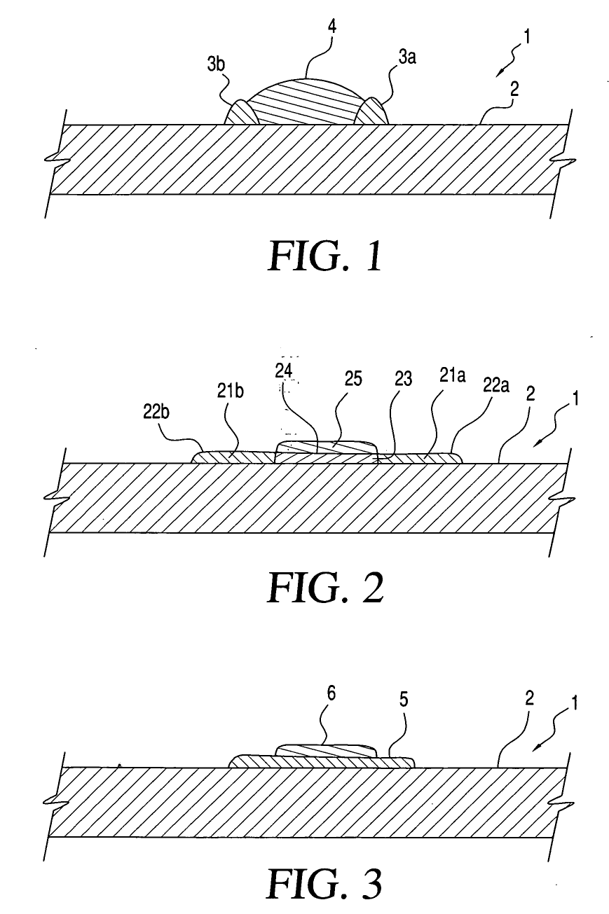

FIG. 1 illustrates an electronic feature formed by an additive process for limiting lateral ink migration. In this embodiment, one or more barrier mediums, e.g., barrier inks, are applied to a first surface 2 of a substrate 1. As shown, two traces 3a and 3b of barrier medium were applied to the first surface 2. Subsequently, an electronic ink 4 is applied to the substrate 1. Specifically, the traces 3a and 3b define an at least partially enclosed region within which the electronic ink is applied. Preferably, the barrier medium or the barrier composition interacts with the electronic ink 4 in a manner sufficient to inhibit the lateral migration thereof.

The barrier medium may be applied to the first surface 2 of substrate 1 by a variety of processes. Preferably, the barrier medium is applied to the substrate 1 by a printing process selected from the group consisting of: lithographic, gravure, flexographic printing, and ink-jet printing. Direct write printing processes such as ink-jet printing are particularly preferred for application of the barrier medium.

In various embodiments, the barrier medium may or may not be cured, heated, or otherwise processed before the application of the electronic ink. It is preferred, however, that the barrier medium be at least partially cured to form the barrier composition prior to the application of the electronic ink. By curing the barrier medium prior to application of the electronic ink, the resulting barrier composition provides a stronger physical barrier to inhibit lateral migration of the subsequently applied electronic ink.

It some aspects, however, it may be desirable to apply the electronic ink after application of the barrier medium but without curing the barrier medium. In this embodiment, the barrier medium preferably interacts with the electronic ink in a repulsive manner even without the curing thereof (or without complete curing). This repulsion may be achieved, for example, by providing ink of opposite polarity, hydrophobicity (see detailed discussion below), or differential viscosity. The opposite polarity ink may gel or precipitate the functional components (or even non-functional components) thereby limiting migration. The opposite hydrophobicity ink may limit migration by limiting the wetting (e.g., penetration). The differential viscosity may provide a physical barrier. An example of a hydrophobic ink may be a polymer emulsion ink.

In a preferred embodiment, the barrier medium is an ink that is applied before the electronic ink. The composition of the barrier ink may vary widely. In a preferred aspect, the barrier medium (and/or the barrier composition formed therefrom) is substantially non-conductive so that it does not electrically interfere with the electronic feature that is ultimately formed. In several preferred aspects, the various possible compositions of barrier inks is similar to the compositions of the planarizing agents described in co-pending U.S. Provisional Patent Application Ser. No. 60/695,412, filed on Jul. 1, 2005, the entirety of which is incorporated herein by reference as if the planarizing agent compositions and the processes for processing same that are disclosed therein referred to barrier ink compositions.

In another additive process, shown in FIG. 3, longitudinal ink migration (e.g., penetration) is inhibited. In this embodiment, a first barrier layer 5 is applied to the first surface 2 of a substrate 1 to form a modified surface. The electronic ink 6 is then applied to the modified surface, which interacts with the electronic ink 6 in a manner sufficient to inhibit longitudinal ink migration. For example, a region fixing ink can be printed prior to deposition of an electronic ink, such as a silver electronic ink, to prevent infiltration of the composition into a porous substrate, such as paper. An example may be an ink containing components effective in precipitating or causing gelation of nanoparticles through ionic strength, reaction chemistry, or other agglomeration methods.

As with the above described additive process, the barrier layer 5 may or may not be cured, e.g., by heating, to form a barrier composition prior to application of the electronic ink 6.

In this embodiment, the area over which the barrier layer 5 is applied preferably is larger than the area covered by the electronic ink 6. Additionally, the electronic ink 6 preferably is applied within at least a portion of the region defined by the barrier layer 5.

One benefit of this aspect of the present invention is that the thickness of electronic features can be more easily controlled since the amount of ink that is absorbed into the substrate is inhibited by the barrier layer. Controlling the thickness of electronic features is important in order to provide repeatable processes for forming electronic features having desired electrical properties. In one aspect, the average thickness of the electronic feature may be greater than about 0.01 μm, e.g., greater than about 0.05 μm, greater than about 0.1 μm, or greater than about 0.5 μm. The thickness can even be greater than about 1 μm, such as greater than about 5 μm. In terms of upper range limitations, the average thickness of the electronic feature optionally is less than about 5 μm, e.g., less than about 1 μm, less than about 0.1 μm, or less than about 0.01 μm. These thicknesses can be obtained by ink-jet deposition or deposition of discrete units of material in a single pass or in two or more passes. For example, a single layer can be deposited and dried, followed by one or more repetitions of this cycle, if desired.

Various subtractive processes also may be used to form barriers that limit electronic ink migration. Trenches and cavities of various shapes and depths below a flat or curved surface confine the flow of the electronic ink. Such trenches can be formed by chemical etching or by photochemical means. The physical structure confining the inks can also be formed by mechanical means including embossing a pattern into a softened surface or means of mechanical milling, grinding or scratching features. Trenches can also be formed thermally, for example by locally melting a low melting point coating such as a wax coating.

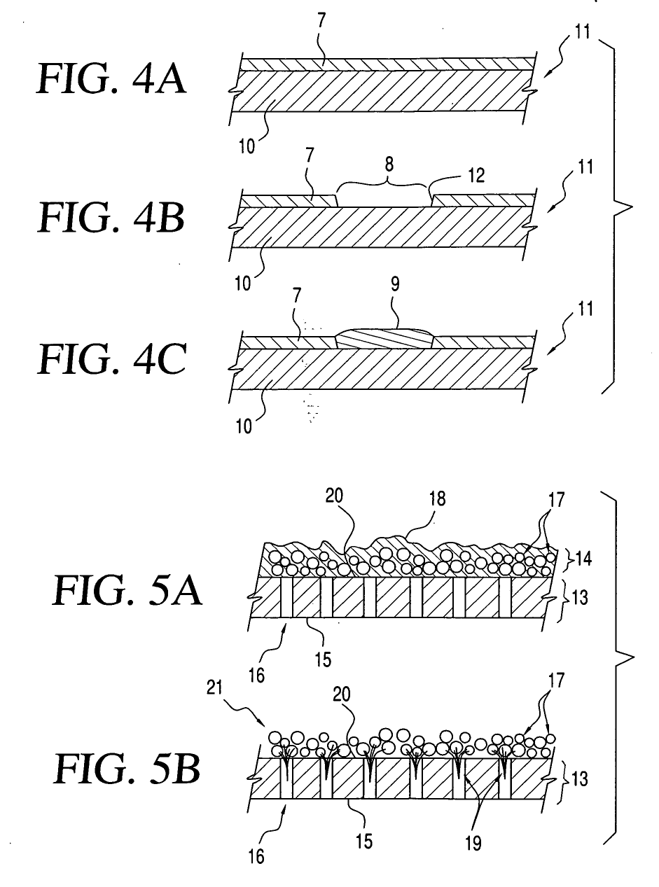

In one subtractive process, shown in FIGS. 4A-4C, lateral ink migration may be inhibited by removing a portion of a preformed multi-layer substrate. In this embodiment, a multi-layer substrate 11 is provided, which multi-layer substrate 11 comprises a base substrate 10 and a barrier composition 7 disposed thereon.

The multi-layer substrate may be formed by a variety of processes. For example, the barrier composition 7 may be formed by applying a barrier medium or layer on the base substrate 10, much in the same manner as discussed above in the additive embodiments. Ideally, the barrier medium or layer preferably is cured to form the multi-layer substrate 11, shown in FIG. 4A. In other aspects, the barrier composition 7 is formed on base substrate 10 by a printing process selected from the group consisting of lithographic, gravure printing, flexographic printing, and ink-jet printing.

In the subtractive process, a portion of the barrier composition 7 is removed from the base substrate 10. The removal of the portion of the barrier composition may be achieved by chemical etching, lasing, stamping, or by other removal processes to form a cavity or trench 8 defined by edges 12 of barrier composition 7, as shown in FIG. 4B. Subsequently, an electronic ink 9 is applied over at least a portion of the trench 8, as shown in FIG. 4C. In this manner, the edges 12 defining trench 8 inhibit lateral migration of the electronic ink 9.

By way of non-limiting example, electronic features in the form of lines can be printed with a thickness of, e.g., about 1 μm and a line width of about 100 μm by ink-jet printing the electronic ink. These data lines can be printed continuously on large substrates with an uninterrupted length of several meters. Surface modification can be employed, as is discussed above, to confine the composition and to enable printing of lines as narrow as about 10 μm. The deposited lines can be heated to about 200° C. to form metal lines with a bulk conductivity that is not less than about 10 percent of the conductivity of the equivalent pure metal.

In one embodiment, the thickness of the barrier composition is as small as possible while providing the desired properties for controlling ink migration. The thickness of the barrier layer will typically depend on the desired thickness of the electronic feature to be formed. In one aspect, the ratio of the thickness (longitudinal) of the barrier composition or layer to the thickness of the ink layer is about 0.25:1 to about 1:1.

B. Inhibiting Ink Migration by Modifying Substrate Surface Energy

In another aspect of the present invention, the surface energy of the substrate is modified in order to inhibit migration of an electronic ink. For example, in a preferred embodiment, the first surface of the substrate is modified to form a modified surface having a surface energy that is either greater than or less than the surface energy of the first surface. In one aspect, surface energy patterning is achieved by increasing or decreasing the hydrophobicity (surface energy) of the surface in selected regions corresponding to where it is desired to confine the electronic ink, and/or in selected regions that are adjacent to where it is desired to confine an electronic ink (barrier composition).

Spreading of an electronic ink is influenced by a number of factors. A drop of liquid placed onto a surface will either spread or not spread depending on the surface tension of the liquid, the surface energy of the solid and the interfacial tension between the solid and the liquid. If the contact angle is greater than about 90 degrees, the liquid is considered non-wetting (e.g., non-penetrating) and the liquid tends to bead or shrink away from the surface. For contact angles less than about 90 degrees, the liquid can spread on the surface. For the liquid to completely wet, the contact angle must be zero. For spreading to occur, the surface energy of the solid must be greater then the combination of the surface tension of the liquid and the interfacial tension between the solid and liquid.

In one aspect of the present invention, an electronic ink may be applied, e.g., by ink-jet deposition, to an unpatterned substrate. Unpatterned refers to the fact that the surface energy (surface tension) of the substrate has not been intentionally patterned for the sole purpose of confining the ink. It is to be understood that variations in surface energy (used synonymously herein with surface tension) of the substrate associated with devices, interconnects, vias, resists and any other functional features may already be present.

In another approach to confining an electronic ink to form a narrow feature, a hydrophilic surface, or a hydrophobic surface that is rendered hydrophilic by surface modification, may be patterned with a hydrophobic pattern. In one aspect, the hydrophobic pattern may, for example, have a surface energy that is at least about 5, at least about 10, at least about 15, at least about 20, at least about 25 or at least about 30 dynes/cm less than that of the surrounding substrate. This can be done by removing a hydrophilic surface layer using a laser to expose a hydrophobic region underneath. A hydrophobic electronic ink may be applied onto at least a portion of the hydrophobic surface regions. The hydrophobic surface region interacts with the hydrophobic electronic ink to confine the electronic ink and limit one or both lateral ink migration and/or longitudinal ink migration.

In a similar embodiment, a hydrophobic surface, or a hydrophilic surface that is rendered hydrophobic by surface modification, may be patterned with a hydrophilic pattern. In one aspect, the hydrophilic pattern may, for example, have a surface energy that is at least about 5, at least about 10, at least about 15, at least about 20, at least about 25 or at least about 30 dynes/cm greater than that of the surrounding substrate. This can be done by removing a hydrophobic surface layer using a laser to expose a hydrophilic region underneath. A hydrophilic electronic ink may be applied onto at least a portion of the hydrophilic surface regions. The surface region interacts with the hydrophilic electronic ink to confine the electronic ink and limit one or both lateral ink migration and/or longitudinal ink migration.

Surfactants, e.g., molecules with hydrophobic tails corresponding to lower surface tension and hydrophilic ends corresponding to higher surface tension may be used to modify the inks and/or substrates to achieve the desired wetting characteristics.

For the purposes of this application, “hydrophobic” means a material that repels water. Thus, hydrophobic materials have low surface energies. They also do not have functional groups for forming hydrogen bonds with water. “Hydrophilic” means a material that has an affinity for water. Hydrophilic surfaces are wetted (e.g., penetrated) by water. Hydrophilic materials also have high values of surface tension. They can also form hydrogen bonds with water. The surface tensions for different liquids are listed in Table 3 and the surface energies for different solids are listed in Table 4.

TABLE 3
SURFACE TENSIONS OF VARIOUS LIQUIDS

| | | Surface |
|---|---|---|
| | Temp | Tension |
| Liquid | (° C.) | (dynes/cm) |
| Water | 20 | 72.75 |
| Acetamide | 85 | 39.3 |
| Acetone | 20 | 23.7 |
| Acetonitrile | 20 | 29.3 |
| n-Butanol | 20 | 24.6 |
| Ethanol | 20 | 24 |
| Hexane | 20 | 18.4 |
| Isopropanol | 20 | 22 |
| Glycerol | 20 | 63.4 |
| Ethylene | 20 | 47.7 |
| glycol | | |
| Tolulene | 20 | 29 |

TABLE 4
SURFACE ENERGIES OF VARIOUS SOLIDS

| | Surface |
|---|---|
| | Energy |
| Material | (dynes/cm) |
| Glass | 30 |
| PTFE | 18 |
| Polyethylene | 31 |
| Polyvinylchloride | 41 |
| Polyvinylidene | 25 |
| fluoride | |
| Polypropylene | 29 |
| Polystyrene | 33 |
| Polyvinylchloride | 39 |
| Polysulfone | 41 |
| Polycarbonate | 42 |
| Polyethylene | 43 |
| terephthalate | |
| Polyacrylonitrile | 44 |
| Cellulose | 44 |

An optional first step may comprise a surface modification of the substrate. The surface modification may be applied to the entire substrate or may be applied in the form of a pattern, such as by using photolithography. The surface modification may, for example, include increasing or decreasing the hydrophilicity of the substrate surface by chemical treatment. For example, a silanating agent can be used on the surface of a glass substrate to increase the adhesion and/or to control spreading of the electronic ink through modification of the surface energy and/or wetting angle. The surface modification may also include the use of a laser to clean the substrate. The surface may also be subjected to mechanical modification by contacting with another type of surface. The substrate may also be modified by corona treatment.

As with the previously discussed physical barrier composition embodiments of the present invention, the modification of the first surface to form a modified surface having a different surface energy than the first surface may be achieved by an additive or subtractive process. In one aspect, for example, the modifying of the first surface is achieved by creating a hydrophilic region on the substrate. The hydrophilic region may be created, for example, by removing a portion of a preformed hydrophobic layer from the multi-layer substrate (comprising a base layer and the hydrophobic layer) or by adding a localized hydrophilic layer to the substrate. In an alternative embodiment, the modifying of the first surface is achieved by creating a hydrophobic region on the substrate. The hydrophobic region may be created, for example, by removing a portion of a preformed hydrophilic layer from the multi-layer substrate (comprising a base layer and the hydrophilic layer) or by adding a localized hydrophobic layer to the substrate.

In several respects, the surface energy modification aspect of the present invention is very similar to the above-described physical barrier composition aspect of the invention. The primary difference between these embodiments is that in the physical barrier composition embodiment, physical interaction between the barrier medium, layer or composition and the electronic ink predominately inhibits migration of the electronic ink, while in the surface energy modification aspect of the invention, it is the difference in surface energy between the modified surface and the electronic ink (relative to the surface energy difference between the unmodified surface and the electronic ink) that predominantly inhibits longitudinal and/or lateral migration of the electronic ink. It is contemplated that the modified surface may include a physical barrier composition, which also has desirable surface energy characteristics for limiting migration of an electronic ink.

Due to the similarity between these two aspects of the present invention, reference may be made to FIGS. 1, 3 and 4A-4C (discussed above with reference to the physical barrier composition embodiment of the present invention) to describe how the surface energy of a substrate may be modified according to the present invention. Reverting to FIG. 1, for example, one or more hydrophobic mediums, e.g., hydrophobic inks, may be applied to a first surface 2 of a substrate 1, as shown by traces 3a and 3b. After preferably curing the applied hydrophobic medium, an electronic ink 4, which ideally is hydrophilic, is applied to the substrate 1, adjacent to and between traces 3a and 3b. Specifically, the traces 3a and 3b define an at least partially enclosed region (e.g., trench) within which the electronic ink 4 is applied. In this embodiment, the optionally cured hydrophobic medium(s) interacts with the hydrophilic electronic ink 4 in a manner sufficient to inhibit the lateral migration thereof. Optionally, the optionally cured hydrophobic medium(s) also acts as a physical barrier to inhibit lateral migration of the subsequently applied electronic ink.

The hydrophobic medium(s) may be applied to the first surface 2 of substrate 1 by a variety of processes. Preferably, the hydrophobic medium(s) is applied to the substrate 1 by a printing process selected from the group consisting of: lithographic, gravure, flexographic printing, and ink-jet printing. Direct write printing processes such as ink-jet printing are particularly preferred for application of the hydrophobic medium(s). Similar direct write printing processes may be used to deposit the hydrophilic electronic ink onto the modified substrate, as discussed in detail above.

In various embodiments, the hydrophobic medium(s) may or may not be cured, heated, or otherwise processed before the application of the hydrophilic electronic ink. It is preferred, however, that the hydrophobic medium(s) be at least partially cured prior to the application of the electronic ink. This curing step causes the liquid vehicle to vaporize, and optionally drives a reaction to form a suitable barrier medium.

In some aspects, however, it may be desirable to apply the electronic ink after application of the hydrophobic medium(s) but without curing the hydrophobic medium(s). In this embodiment, the hydrophobic medium(s) preferably interacts with the electronic ink in a repulsive manner even without the curing thereof (or without complete curing).

It should be understood that although the above-described process employs a hydrophobic medium, e.g., hydrophobic ink, to form a modified surface, which inhibits migration of a hydrophilic electronic ink, the inventive process may instead employ a hydrophilic medium and a hydrophobic electronic ink. For example, the process may include the steps of: (1) applying one or more hydrophilic mediums, e.g., hydrophilic inks, to a first surface; (2) optionally curing the applied hydrophilic medium(s); and (3) applying a hydrophobic electronic ink to the first substrate, adjacent the traces formed by the applied and optionally cured hydrophilic medium(s).

Reverting to FIG. 3, longitudinal ink migration (e.g., penetration) may also be inhibited by modifying the surface energy of the substrate without necessarily forming a barrier composition. In one aspect of this embodiment, a first hydrophobic medium(s) 5 is applied to the first surface 2 of a substrate 1 to form a modified surface. As with the above described additive process, the hydrophobic medium(s) 5 may or may not be cured, e.g., by heating, to form a hydrophobic composition prior to application of the electronic ink 6. The electronic ink 6, which is hydrophilic, is then applied to the modified surface (specifically on the first hydrophobic medium 5 or, if cured, the hydrophobic composition), which interacts with the applied electronic ink 6 due to the difference in surface energies between the two compositions in a manner sufficient to inhibit one or both lateral ink migration and/or longitudinal ink migration. In this embodiment, the area over which the hydrophobic medium(s) 5 is applied preferably is larger than the area covered by the electronic ink 6. Additionally, the electronic ink 6 preferably is applied within at least a portion of the region defined by the hydrophobic medium(s) 5.

Of course, it is also contemplated that the electronic ink may be hydrophobic, and the modified surface may be hydrophilic. That is, a first hydrophilic medium 5 may be applied to the first surface 2 of the substrate 1 and optionally cured to form the modified surface.

In another aspect, a first ink is applied to a substrate and a second electronic ink is applied on top of at least a portion of the applied first ink in a manner shown, for example, in FIG. 3. In this aspect, however, rather than hydrophobic/hydrophilic interactions limiting ink migration, as discussed above, another repulsive interaction inhibits ink migration. For example, the repulsion may be achieved by providing first and second inks of opposite polarity or differential viscosity. The opposite polarity ink may gel or precipitate the functional components (or nonfunctional components) to limit longitudinal ink migration. The differential viscosity may provide a physical barrier, which inhibits longitudinal ink migration.

FIG. 2 illustrates another additive embodiment of this aspect of the present invention. In this embodiment, two different inks are applied to first surface 2 of substrate 1. As shown, a first ink 23 is applied on surface 2 of substrate 1, and a second ink 21a, 21b is applied adjacent the sides of first ink 23 also on surface 2 of substrate 1. The properties of the two inks may vary widely, but preferably each of the two inks has at least one property that differs from the another in at least one interactive manner. For example, the inks may opposite hydrophobicities, polarities and/or viscosities, as discussed above. As shown, second ink 21a, 21b is applied in traces on each side of the first ink 25. Subsequently, after optional curing of the two applied inks, an electronic ink 25 is applied on top of one of the two applied inks. As shown, electronic ink 25 is applied to surface 24 of first ink 23. Preferably, the electronic ink 25 selectively interacts with either or, preferably, both of the two previously applied inks in a manner effective to inhibit lateral migration of the electronic ink 25.

In one example of this embodiment, first ink 23 and electronic ink 25 may both be hydrophobic and second ink 21a, 21b may be hydrophilic. As a result, the electronic ink 25 interacts with first ink 23 at surface 24 in an attractive manner, while at the same time, electronic ink 25 interacts with surfaces 22a, 22b of second ink 21a, 21b in a repulsive manner. As a result, the combination of attractive and repulsive interactions inhibits lateral migration of the applied electronic ink 25. In a related embodiment, electronic ink 25 and first ink 23 are hydrophobic, and second ink 21a, 21b is hydrophilic. Similar effects may be achieved with viscosity and/or opposite polarity interacts between the electronic ink 25 and the first and second inks 23 and 21a, 21b, respectively.

Importantly, the subtractive process reflected in FIGS. 4A-4C also may be used to modify the surface energy of a substrate. Specifically, FIGS. 4A-4C reflect that lateral ink migration may be inhibited by removing a portion of a preformed multi-layer substrate to modify the surface energy thereof. In this embodiment, a multi-layer substrate 11 is provided, which multi-layer substrate 11 comprises a base substrate 10 and a hydrophobic layer 7 disposed thereon.

The multi-layer substrate may be formed by a variety of processes. For example, the hydrophobic layer 7 may be formed by applying a hydrophobic medium on the base substrate 10, much in the same manner as discussed above in the additive embodiments. Ideally, the hydrophobic medium or layer is cured to form the multi-layer substrate 11, shown in FIG. 4A. In other aspects, the hydrophobic composition 7 is formed on base substrate 10 by a printing process selected from the group consisting of lithographic, gravure, flexographic, and ink-jet printing.

In the subtractive process, a portion of the hydrophobic composition 7 is removed from the base substrate 10. The removal of the portion of the hydrophobic composition may be achieved by chemical etching or lasing to form a cavity or trench 8 defined by edges 12 of hydrophobic composition 7, as shown in FIG. 4B. Subsequently, a hydrophilic electronic ink 9 is applied over at least a portion of the trench 8, as shown in FIG. 4C. In this manner, the edges 12 defining trench 8 act as a physical barrier inhibiting lateral migration of the electronic ink 9. Additionally, the hydrophobic composition 7 interacts with the hydrophilic electronic ink 9 further limiting lateral migration.

In this embodiment, it is also contemplated that the electronic ink 9 may be hydrophobic rather than hydrophilic, in which case the multi-layer substrate 11 preferably comprises a base substrate 10 and a hydrophilic composition or layer disposed thereon (rather than hydrophobic composition 7).

Offset printing or lithographic printing can be used to print high resolution patterns that correspond to at least two levels of surface energies. In one aspect, the printing is carried out on a hydrophobic surface and a hydrophilic material (ink) is printed. The regions where no printing occurs correspond to hydrophobic material. A hydrophobic electronic ink can then be printed onto the hydrophobic regions thereby confining the ink. Alternatively, a hydrophilic nanoparticle ink can be printed onto the hydrophilic electrostatically printed regions. The width of the hydrophobic and hydrophilic regions may be not greater than about 100 μm, e.g., not greater than about 75 μm, not greater than about 50 μm, or not greater than about 25 μm.

The ink confinement may be accomplished by applying a photoresist and then laser patterning the photoresist and removing portions of the photoresist. The confinement may be accomplished by a polymeric resist that has been applied by another jetting technique or by any other technique resulting in a patterned polymer. In one aspect, the polymeric resist is hydrophobic and the substrate surface is hydrophilic. In that case, the ink utilized is hydrophilic resulting in confinement of the ink in the portions of the substrate that are not covered by the polymeric resist.

It is important to note that while the above-described surface energy modification embodiments have described a hydrophobic medium or layer inhibiting the migration of a hydrophilic ink, the invention is not so limited. In fact, the surface energy modification aspect of the invention works equally well for hydrophobic inks. That is, hydrophilic medium(s) or layers may be used to limit migration (lateral and/or longitudinal) of hydrophobic electronic inks with great success, and one skilled in the art would appreciate that the above description applies equally to limiting migration of hydrophobic inks with a hydrophilic medium or layer.

As indicated above, in a preferred embodiment, the modified surface, on which or adjacent to which the electronic ink is applied, has a surface energy that is substantially different from the surface energy of the electronic ink. For example, if the electronic ink is hydrophobic, then the modified surface preferably is hydrophilic. On the other hand, if the electronic ink is hydrophilic, then the modified surface preferably is hydrophobic. In various embodiments, the absolute value of the difference between the surface energy of the modified surface and the surface energy of the electronic ink may be greater than about 5 dynes/cm, e.g., greater than about 10 dynes/cm or greater than about 15 dynes/cm. In terms of upper range limitations, optionally in combination with the aforementioned lower range limitations, the absolute value of the difference between the surface energy of the modified surface and the surface energy of the electronic ink optionally is less than about 25 dynes/cm, e.g., less than about 20 dynes/cm or less than about 15 dynes/cm.

In some aspects, it may be desirable to form the barrier medium and/or composition formed therefrom of a material having a surface energy that is similar to the surface energy of the electronic ink that is applied. This aspect may be beneficial, for example, if it is desired for the two materials to interact in some manner, e.g., react to form a precipitant and/or gelation in order to inhibit migration.

A laser can also be used in various ways to modify the surface energy of a substrate in a patterned manner. The laser can be used, for example, to oxidize a surface and form hydroxyl groups, rendering the patterned surface hydrophilic (or more hydrophilic). The resulting patterned regions are converted to more hydrophilic regions that can be used to confine a hydrophobic or, more likely, a hydrophilic ink. The laser may also be used to remove selectively a previously applied surface layer, as discussed above. In one preferred embodiment, the laser selectively removes a previously applied surface layer that was formed by chemical reaction of the surface with a silanating agent.

In one aspect, a surface is laser processed to increase the hydrophilicity in regions where the laser strikes the surface. A polyimide substrate is coated with a thin layer of hydrophobic material, such as a fluorinated polymer. A laser, such as a pulsed YAG, excimer or other UV or shorter wavelength pulsed laser, can be used to remove the hydrophobic surface layer exposing the hydrophilic layer underneath. Translating (e.g., on an x-y axis) the laser allows patterns of hydrophilic material to be formed. Subsequent application of a hydrophilic ink to the hydrophilic regions allows confinement of the ink. Alternatively, a hydrophobic ink can be used and applied to the hydrophobic regions resulting in ink confinement.

In another aspect, a surface is laser processed to increase the hydrophobicity in regions where the laser strikes the surface. For example, a hydrophobic substrate such as a fluorinated polymer can be chemically modified to form a hydrophilic layer on its surface. Suitable modifying chemicals include solutions of sodium naphthalenide. Suitable substrates include polytetrafluoroethylene and other fluorinated polymers. The dark hydrophilic material formed by exposing the polymer to the solution can be removed in selected regions by using a laser. Continuous wave and pulsed lasers can be used. Hydrophilic inks, for example aqueous based inks, can be applied to the remaining dark material. Alternatively, hydrophobic inks, such as those based on solutions in non-polar solvents, can be applied to the regions where the dark material was removed leaving the hydrophobic material underneath. Ceramic surfaces can be hydroxylated by heating in moist air or otherwise exposing the surface to moisture. The hydroxylated surfaces can be silanated to create a monolayer of hydrophobic molecules. The laser can be used to selectively remove the hydrophobic surface layer exposing the hydrophilic material underneath. A hydrophobic patterned layer can be formed directly by micro-contact printing using a stamp to apply a material that reacts with the surface to leave exposed a hydrophobic material such as, e.g., an aliphatic hydrocarbon chain. The ink or inks can be applied directly to the hydrophilic regions or hydrophobic regions using a hydrophilic or hydrophobic electronic ink, respectively.

A surface with patterned regions of hydrophobic and hydrophilic regions can be formed by micro-contact printing. In this approach, a stamp is used to apply a reagent to selected regions of a surface. This reagent can form a self-assembled monolayer that provides a hydrophobic surface. The regions between the hydrophobic surface regions can be used to confine a hydrophilic inks.

C. Inhibiting Ink Migration with an Adhesion Promoter

As indicated above, in one aspect of the invention an adhesion promoter is used to inhibit one or both lateral and/or longitudinal migration of an electronic ink. The adhesion promoter may be applied to a substrate in a first step prior to the application of the electronic ink (e.g., by applying a first ink to the substrate to form an initial coating layer or trace thereon). Alternatively, the adhesion promoter may be a component in the electronic ink itself.

Thus, the first ink and/or the electronic ink optionally includes an adhesion promoter for improving the adhesion of the electronic ink (and/or at least a portion of the feature formed therefrom) to the underlying substrate. It has been found that electronic features made from the inks described herein show a satisfactory to excellent adhesion to various substrates without the presence of adhesion promoters. For example, in the case of preferred inks such as those which comprise metallic nanoparticles and in particular, silver nanoparticles and polyvinylpyrrolidone as an anti-agglomeration agent, it has been found that the anti-agglomeration substance itself may act as adhesion promoter, especially in the case of polymeric substrates. Further, the adhesive strength may be dependent, inter alia, on the processing temperature of the deposited ink(s). Particularly, even in the absence of separately added adhesion promoters the preferred inks of the present invention have been found to exhibit very good adhesion to FR4 (glass fibers impregnated with epoxy resin) substrates when processed (cured) in the temperature range of from about 100° C. to about 180° C., satisfactory to very good adhesion to MYLAR® substrates in the temperature range of from about 100° C. to about 180° C., satisfactory adhesion to KAPTON® substrates at temperatures of about 200° C. and higher, and to glass substrates at temperatures of about 350° C. and higher. Good to excellent adhesion to ITO substrates has been observed at temperatures of about 350° C. and higher.

Especially in the case of glass surfaces, the adhesion of silver-containing electronic inks can be (significantly) improved by the addition of an adhesion promoter. Non-limiting examples of adhesion promoters that may be included in the electronic ink itself (with silver and other metals which would benefit from the use of an adhesion promoter) or a secondary ink include metals as well as metal compounds which are oxides or can be converted to oxides by thermal decomposition, oxidation in an oxygen containing atmosphere, etc. Non-limiting examples of metals for the adhesion promoter include B, Si, Pb, Cu, Zn, Ni and Bi. Especially in the case of a glass substrate, a low melting point glass is yet another example of a suitable adhesion promoter. A specific example of a preferred adhesion promoter is bismuth nitrate (which decomposes to form bismuth oxide at a temperature of about 260° C.). By way of non-limiting example, an atomic ratio Ag:Bi in the range of from about 15:1 to about 7:1 may be particularly advantageous. The addition of bismuth nitrate results in a consistently good adhesion of deposited silver to glass surfaces over the entire tested temperature range of from about 100° C. to about 550° C.

In the case of, e.g., nickel-containing inks, on the other hand, the adhesion to glass substrates is good even without the presence of an adhesion promoter. This may be due to the formation of nickel oxide during the thermal processing of a deposited nickel nanoparticle composition of the present invention.

Of course, in addition to bismuth nitrate and the other adhesion promoters mentioned above, there are a variety of other adhesion promoters that can afford desirable results when included in the ink(s). The effectiveness of a given adhesion promoter will usually depend, inter alia, on the metal of the nanoparticle, the substrate, the processing temperature, etc. The adhesion promoter is preferable soluble in the liquid vehicle, but may also be present in the form of, e.g., ultrafine particles that are dispersed in the liquid vehicle. In other words, adhesion promoters can be added to the ink in particulate form (e.g., in the case Ni in the form of nickel nanoparticles). Further non-limiting examples of adhesion promoters for use in the present invention are disclosed in, e.g., U.S. Pat. No. 5,750,194, the entire disclosure of which is incorporated herein by reference in its entirety. Furthermore, polymers such as, e.g., polyamic acid, acrylics and styrene acrylics can improve the adhesion of a metal to a polymer substrate, as can substances such as coupling agents, titanates and silanes.

An adhesion promoter can also be added to the ink in the form of a metal precursor to a metal (e.g., a chemical precursor to a metal) such as, e.g., in the form of a metal salt (e.g., a carboxylate or nitrate), a metal alkoxide, etc. Adhesion promoters can also be applied to the substrate prior to printing of a nanoparticle ink, preferably by the same printing method but optionally also by an alternative method such as, e.g., spin coating or dip coating.

It is to be noted that, in certain cases the polymer that serves the function of an anti-agglomeration substance for the nanoparticles of, e.g., an ink, may also provide improved structural integrity on a variety of substrates when curing is performed at relatively low temperatures (e.g., from about 75° C. to about 350° C.). At such low temperatures, the polymer (shell) will not volatilize, but rather rearrange while allowing the metal cores of the particles to touch and sinter together. The polymer now can serve the function of adhesion promoter between the metallic nanoparticles and the substrate. In addition, it may also provide additional cohesive strength between individual particles.

Optionally, an adhesion material/promoter can be printed onto a substrate prior to printing of the electronic ink. In effect, the adhesion promoter acts as a primer to facilitate adhesion of the subsequently applied electronic ink to the modified surface. By way of non-limiting example, in a preferred aspect of the present invention, a metal, metal oxide, or low melting point glass structure may be ink-jet printed on a glass substrate followed by ink-jet printing of a metal (e.g., silver) structure on top of the first printed structure. After heating, the adhesion material/promoter will improve the adhesion of the metal (e.g., Ag) structure to the glass substrate. In another non-limiting example, a metal, metal oxide, or low melting point glass structure may be ink-jet printed on an ITO coated glass substrate followed by ink-jet printing of a metal (e.g., silver) structure on top of the first printed structure. After heating, the adhesion material/promoter structure will improve adhesion of the metal structure to the glass substrate. These examples may also be applied to inhibit migration of non-metallic electronic inks.

D. Limiting Ink Migration by Forming a Region Having an Opposite Charge that the Electronic Ink

In one aspect of the invention, either or both lateral and/or longitudinal ink migration is inhibited by electronic interactions between adjacent layers.

Specifically, in a first step, a first surface of a substrate is modified by forming a first layer, which is either cationic or anionic, on the substrate. Subsequently, a second layer (e.g., the electronic ink) is formed on the first layer, at least in part. In this embodiment, the second layer is cationic if the first layer is anionic, and the second layer is anionic if the first layer is cationic. In this embodiment, the charge differential between the first and second layers creates strong ionic coupling effects between the two layers. That is, the first layer interacts with the second layer at an interface between the first and second layers to inhibit one or both lateral and/or longitudinal migration of the second layer.

In one particularly preferred embodiment, the interaction between the first and second layers causes a precipitant (or gel) to form at the interface between the two layers. The precipitation/gelation reaction can occur because of change in ionic strength (e.g., the first layer is high ionic strength, which causes the particles in the second layer to precipitate). The reaction can be a specific interaction between materials in the first and second layers, e.g., a precipitation of a colloid or polyelectrolyte by reaction with polyvalent materials such as divalent metals or polyelectrolytes of opposite charge. An example of the latter embodiment includes reacting an anionic polymer and a cationic polymer. The key is that the reactive materials in each ink be soluble or dispersible in one another so that when they come in contact with one another, precipitation and/or gelation occurs. This precipitant or gel formed preferably acts as a barrier composition, as discussed above. That is, the precipitant forms a barrier composition between the first and second layers, which barrier composition inhibits either or both lateral and/or longitudinal migration of the second layer (e.g., electronic ink).

In various aspects of the invention, the first layer may comprise one or more multivalent metals, e.g., Ca²⁺, Mg²⁺, Al²⁺, Zn²⁺, etc. Additionally or alternatively, the first layer comprises one or more cationic polymers, cationic amine polymers, polyethylene imine, allyl amine, other quat polymers, and/or quaternize polyvinyl pyrollidone. The second ink or second layer formed therefrom optionally comprises one or more of the following: functional electronic materials, anionic polymers, such as acrylic polymers, maleic anhydride polymers, polyurethanes.

In another embodiment, the acidity (pH) of the substrate and/or ink may be used to control lateral and/or longitudinal ink migration. For example, in one embodiment, the substrate, optionally a modified substrate, has a surface that exhibits a certain pH that interacts with a subsequently applied electronic ink to inhibit ink spreading. For example, the substrate optionally is precoated with a material rich in acid, which facilitates coagulation or precipitation of one or more components (e.g., polymers, optionally anionic polymers) contained in the subsequently applied electronic ink. In this aspect, a first layer having a pH less than 7, e.g., less than 6, less than 5, less than 4, or less than 3 is, or less than 2, is applied to an initial substrate to form a first substrate. Optionally the first layer is treated, e.g. with heat radiation, UV radiation or IR radiation, so as to secure (optionally by curing) the first layer to the initial substrate. Subsequently, a second layer (e.g., the electronic ink) is formed on the first substrate (e.g., on the first layer), at least in part. In this embodiment, the second layer preferably interacts with the acidic first layer, so as to inhibit longitudinal and/or lateral migration of the second layer at an interface therebetween.

E. Limiting Ink Migration Based on Substrate Porosity

Yet another method for controlling the spreading during printing according to the present invention comprises the steps of depositing an ink onto a porous substrate, thereby limiting the spreading of the ink, and converting the ink to a desired structure, e.g., an electronic feature. In one aspect, the porosity in the substrate is created by laser patterning. The porosity can be limited to the very surface of the substrate.

Yet another method for controlling the spreading of a low viscosity inks according to the present invention includes the steps of patterning the substrate to form regions with two (or more) distinct levels of porosity where the a patterned porous region forms the pattern of a desired structure. The electronic ink(s) can then be deposited, such as by ink-jet printing, onto the patterned porous region defining the pattern thereby confining the electronic ink(s) to these regions, and converting the deposited ink(s) to a desired structure, e.g., an electronic feature such as an electrical conductor. Exemplary substrates useful for this aspect of the invention include polyimides, epoxy laminates, fluorinated polymers, epoxy resins (including glass-filled epoxy resin), polycarbonates, polyester, polyethylene, polypropylene, polyvinyl chloride, ABS copolymer, synthetic paper, and non-woven polymeric fabric. In one aspect the patterning may be carried out with a laser. In another aspect the patterning may be carried out using photolithography. In another aspect, capillary forces pull at least some portion of the ink into the porous substrate.

This embodiment of the present invention is particularly desirable for electronic inks that comprise certain anti-agglomeration agents, particularly PVP. It has now been discovered that PVP may be selectively wicked into substrate pores through capillary action. This action creates a strong bond between the substrate and the electronic ink applied thereto.

The pore sizes implemented in this embodiment of the invention may vary widely, depending primarily on the relative particle sizes of one or more functional electronic materials (e.g., metallic and/or non-metallic nanoparticles) contained in the electronic ink. In one embodiment, for example, the average pore size for the patterned (porous) region is about the same size as the average particle size of the functional electronic material(s) contained in the electronic ink. In other embodiments, the average pore size of the patterned region is greater than (e.g., at least 1.5 times, at least 2.0 times, or at least about 3.0 times greater than) the average particle size of the functional electronic material(s) contained in the electronic ink. Alternatively, the average pore size of the patterned region is less than (e.g., at least about 1.5 times, at least about 2.0 times or at least about 3.0 times less than) the average particle size of the functional electronic material(s) contained in the electronic ink.

FIGS. 5A and 5B illustrate this aspect of the present invention. As shown in FIG. 5A, an electronic ink 14 comprising metallic nanoparticles 17 and an anti-agglomeration agent 18 is shown disposed on a substrate surface 20 of substrate 13. FIG. 5A shows the electronic ink after removal of a majority of the liquid vehicle. Substrate 13 is porous having a plurality of pores 16 in a base material 15. The pores are shown extending through substrate 13, although it is contemplated that the pores may only partially extend into substrate 13.

After application of the electronic ink 14 onto substrate 13, capillary action causes the mobile fluids (e.g., liquid vehicle or a portion thereof) including the anti-agglomeration agent 18 to wick into the pores 16. Thus, after applying the electronic ink onto the substrate surface 20, at least a portion of the anti-agglomeration agent is drawn into the substrate pores 16. A portion of the anti-agglomeration agent may remain adhered to the nanoparticles 17, thereby establishing a strong bond between the nanoparticles 17 and the substrate 13. Importantly, this bonding action causes the electronic ink to adhere to the substrate surface and inhibits lateral migration. Longitudinal migration is not a problem so long as the nanoparticles 17 are generally larger in size than the substrate pores. Additionally, by causing at least a portion of the anti-agglomeration agent 18 to disassociate from the nanoparticles 17, the conductivity of the resulting electronic feature 21 may be increased relative to the conductivity of the electronic ink 14. Ultimately, a tightly packed filter cake is formed, which is capable having particularly high conductivity (if desired). Additionally, due to the disassociation of the anti-agglomeration agent 18 from the nanoparticles, conditions required for curing of the electronic ink 14 may be significantly milder than for other electronic ink/substrate combinations.

Ultimately, a tightly packed filter cake is formed, which is capable having particularly high conductivity (if desired).

F. Encouraging Ink Migration

In some circumstances, it may be desirable to facilitate the lateral migration (spreading) of an electronic ink. For example, it may be desired to form very thin layers to develop gaps in, e.g., semiconductor fabrication. Facilitating ink spreading may also be helpful to control “over feature” dimensions and electronic feature size. For example, it may be desired to carefully control the resistively value of a resistor during printable resistor fabrication. Controlling resistivity may be achieved by controlling the resistor size, e.g., volume, which is proportional to the resistance of the resistor formed. Additionally, this aspect of the invention may be desired to achieve maximum coverage per drop, thereby minimizing unnecessary waste of the electronic inks.

In one aspect, the present invention is to a process facilitating the spreading of an electronic ink on a substrate with a surfactant during the formation of at least a portion of an electronic feature. The process includes the steps of: (a) providing a substrate; (b) forming a first layer on the substrate, wherein the first layer comprises a surfactant; and (c) contacting a second layer with the first layer, at least in part, under conditions effective to cause the second layer to spread laterally to a greater extent than if the second layer were formed on the substrate without the first layer. In this embodiment, the second layer forms the at least a portion of the electronic feature.

In this aspect of the invention, the first layer may be applied to the substrate before, after or substantially simultaneously with the second layer. That is, in one aspect, the first layer is applied on a substrate and a second layer (e.g., the electronic ink layer) is applied on top of the first layer, at least in part. In another aspect, the second layer is applied to the substrate and the first layer comprising the surfactant is applied on top of the first layer. What is important is that the second layer contacts the first layer, at least in part, under conditions effective to cause the second layer to spread laterally to a greater extent that if the second layer were formed on the substrate without the first layer.

The types of surfactant in the first layer may vary widely. Some non-limiting examples of preferred surfactants for use in this embodiment of the present invention include fluoronated surfactants, such as FLUORAD® (3M), ZONYL® (duPont); non-ionic surfactants such as TERGITOL®, SURFYNOL®, or siloxanes; and ionic surfactants. Preferably, the surfactant creates a surface tension in the first layer that is lower than the surface tension of the second layer (e.g., electronic ink). Typically, the surface tension of the second layer (e.g., electronic ink) is less than about 25 dynes/cm.

Preferably, the first layer is applied to the substrate by a printing process selected from the group consisting of: lithographic, gravure printing, flexographic, and ink-jet printing. Direct write printing processes such as ink-jet printing are particularly preferred for application of the first layer onto the substrate surface.

Ideally, the first layer is not heated or otherwise cured prior to the application of the second layer thereto. By not curing the first layer prior to applying the second layer, the first and second layers are allowed to freely mix on the substrate as the electronic ink spreads. It may be desired to cure the resulting mixed composition after the desired spreading. In this aspect, a curing step may be timed to control the degree of spreading. For example, once the desired degree of spreading has been obtained (or as the desired degree of spreading is approached), the spreading may be slowed or halted by curing the resulting mixture.

### IV. EXAMPLES

The present invention will be better understood in view of the following non-limiting examples.

### A. Example 1

### Treating a Kapton Substrate with a Hydrophobic Chemical Agent

The following are examples that demonstrate the effect of treating a Polyimide (Kapton) film with a hydrophobic chemical agent combined with printing a silver nanoparticle-containing ink onto the substrate.

An ITI XY print system equipped with a Spectra SX-128 ink jet head was set up to print a silver nanoparticle-containing ink comprising approximately 55 weight percent silver. An image comprising single pixel lines having a resolution of 1,050 dots per inch was created and used in this example. The Kapton substrate was cleaned by wiping the substrate with denatured ethanol to remove some of the organic contaminants.

Sample 1 (control) did not receive any additional surface modification and was not treated with a hydrophobic chemical agent. Once the ink was deposited onto the substrate via the Spectra SX-128 ink jet head, the substrate was placed in a forced air convection oven at 200° C. for 10 minutes to cure the ink sample.

Sample 2 was prepared in a manner similar to Sample 1, but a hydrophobic chemical agent was used on the substrate surface. All of the steps described for the control sample were followed with the exception of how the surface of the Kapton was prepared. For Sample 2, the substrate was first cleaned with denatured ethanol, then wiped using a clean Kimwipe™ cloth saturated with a hydrophobic chemical agent (in this case, a commercially available automotive glass surface treatment chemical known as Rain-X™). Following the application of the hydrophobic chemical agent, the substrate was again cleaned with denatured ethanol to remove excess hydrophobic chemical agent. All other parameters were kept the same as those for Sample 1, such as the print system, print head, image, and image resolution, cure temperature and time.

Measurements taken on two traces of Sample 1 (control) showed trace widths of 67.2 μm and 76.0 μm respectively. The measurements taken on two traces of Sample 2 showed trace widths of 58.4 μm and 56.2 μm respectively. The hydrophobic chemical agent surface treatment on the Kapton substrate in Sample 2 caused a narrowing of the printed lines versus the untreated Sample 1. This narrowing behavior has a benefit of allowing more printed traces per unit area than that of an untreated sample.

### B. Example 2

### Treating a LCD Glass Substrate with a Hydrophobic Chemical Agent

A second example demonstrated the effect of treating a Liquid Crystal Display (LCD) Glass substrate, or more specifically, Eagle 2000 by Corning Inc., with a hydrophobic chemical agent combined with printing a silver nanoparticle-containing ink onto the substrate.

An ITI XY print system equipped with a Spectra SX-128 ink jet head was set up to print a silver nanoparticle-containing ink comprising approximately 55 weight percent silver. Images comprising single pixel lines and having a resolution of both 750 dots per inch (Sample 3) and 1,050 dots per inch (Sample 4) were created and used in this example. The LCD Glass substrate was cleaned by wiping the substrate with denatured ethanol to remove some of the organic contaminants.

Sample 3 (control) did not receive any additional surface modification and was not treated with a hydrophobic chemical agent. Further, the 750 dots per inch image (rather than 1050 dpi) was printed onto the substrate to eliminate the chance that the lines would bleed together due to their close proximity. Sample 3 was prepared by wiping the surface with both denatured ethanol followed by wiping the surface with Acetone.

Sample 4 was prepared in a manner similar to Sample 3, but received a hydrophobic chemical agent treatment (in this case, a diluted mixture of Scotchguard™ by 3M Corp. and isopropyl alcohol). Both samples of LCD glass underwent a UV Ozone treatment for 10 minutes before applying any additional surface treatments. Once the ink was deposited onto both substrates via the Spectra SX-128 ink jet head, the substrates were placed in a forced air convection oven at 300° C. for 30 minutes to cure the ink samples.

Measurements taken on two traces of Sample 3 (control) showed trace widths of 111.3 μm and 105.2 μm, respectively, while measurements of two traces of Sample 4 showed trace widths of 48.4 μm (for both). This example illustrates that the treatement of LCD glass with a hydrophobic chemical agent, such as Scotchguard™ by 3M Corp., enabled the ability to print narrow lines, even in the case of increased resolution.

It is understood that the words that have been used herein are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

We claim:

1. A process for forming at least a portion of an electronic feature, the process comprising the steps of:
(a) providing a first substrate having a first surface;
(b) modifying the first surface to form a modified surface; and
(c) applying an ink to at least a portion of the modified surface, wherein the modified surface interacts with the ink to inhibit one or both lateral migration and/or longitudinal migration of the applied ink, and wherein the applied ink forms at least a portion of the electronic feature.

2. The process of claim 1, wherein the first surface has a first surface energy and the modified surface has a second surface energy greater than the first surface energy.

3. The process of claim 2, wherein the absolute value of the difference between the first surface energy and the second surface energy is greater than about 10 dynes/cm.

4. The process of claim 1, wherein the first surface has a first surface energy and the modified surface has a second surface energy less than the first surface energy.

5. The process of claim 4, wherein the absolute value of the difference between the first surface energy and the second surface energy is greater than about 10 dynes/cm.

6. The process of claim 1, wherein step (c) is achieved using a direct write printing process.

7. The process of claim 1, wherein the first substrate is selected from the group consisting of FR4, a fluorinated polymer, polyimide, epoxy resin, polycarbonate, polyester, polyethylene, polypropylene, polyvinyl chloride, ABS copolymer, wood, paper, metallic foil, glass, flexible fiberboard, non-woven polymeric fabric, and cloth.

8. The process of claim 1, wherein the first substrate comprises a base substrate and a hydrophobic layer disposed thereon, and wherein step (b) comprises removing a portion of the hydrophobic layer to form the modified surface.

9. The process of claim 8, wherein the removing is achieved by etching, lasing, or by applying a chemical to a portion of the first substrate.

10. The process of claim 1, wherein the process further comprises the step of:
(d) applying a hydrophobic layer to an initial substrate to form the first substrate,
and wherein step (b) comprises removing a portion of the hydrophobic layer to form the modified surface.

11. The process of claim 10, wherein the removing is achieved by etching, lasing, or by a chemical.

12. The process of claim 10, wherein the hydrophobic layer comprises a component selected from the group consisting of a polymer, a wax, a curable polymer, and a passivation agent.

13. The process of claim 1, wherein the first substrate comprises a base substrate and a hydrophilic layer disposed thereon, and wherein step (b) comprises removing a portion of the hydrophilic layer to form the modified surface.

14. The process of claim 13, wherein the removing is achieved by etching, lasing, or by applying a chemical to a portion of the first substrate.

15. The process of claim 13, wherein the base substrate comprises glass and the hydrophilic layer comprises a component selected from the group consisting of a strong base, a hydrophilic coupling agent, and a hydrophilic polymer.

16. The process of claim 1, wherein the process further comprises the step of:
(d) applying a hydrophilic layer to an initial substrate to form the first substrate,
and wherein step (b) comprises removing a portion of the hydrophilic layer to form the modified surface.

17. The process of claim 16, wherein the removing is achieved by etching, lasing, or by a chemical.

18. The process of claim 16, wherein the hydrophilic layer comprises a component selected from the group consisting of a strong base, a hydrophilic coupling agent, and a hydrophilic polymer.

19. The process of claim 1, wherein the ink comprises a metallic composition.

20. The process of claim 19, wherein the metallic composition comprises a metal selected from the group consisting of silver, gold, copper, nickel, cobalt, palladium, platinum, indium, tin, zinc, titanium, chromium, tantalum, tungsten, iron, rhodium, iridium, ruthenium, osmium and lead.

21. The process of claim 19, wherein the metallic composition comprises an alloy comprising at least two metals, each of the two metals being selected from the group consisting of silver, gold, copper, nickel, cobalt, palladium, platinum, indium, tin, zinc, titanium, chromium, tantalum, tungsten, iron, rhodium, iridium, ruthenium, osmium and lead.

22. The process of claim 21, wherein the alloy comprises a combination of metals selected from the group consisting of silver/nickel, silver/copper, silver/cobalt, platinum/copper, platinum/ruthenium, platinum/iridium, platinum/gold, palladium/gold, palladium/silver, nickel/copper, nickel/chromium, and titanium/palladium/gold.

23. The process of claim 21, wherein the alloy comprises at least three metals.

24. The process of claim 1, wherein the modified surface includes pores.

25. The process of claim 24, wherein the pores are formed by laser patterning.

26. The process of claim 24, wherein the pores are formed by photolithography.

27. The process of claim 24, wherein capillary forces pull at least some portion of the ink into the pores to inhibit migration of the applied ink.

28. The process of claim 1, wherein the electronic feature is selected from the group consisting of a conductor, a resistor, a capacitor, an inductor, a dielectric and a semiconductor.

29. A process for forming at least a portion of an electronic feature, the process comprising the steps of:
(a) providing a first substrate having a base substrate and a barrier layer disposed thereon; and
(b) applying an ink to at least a portion of the barrier layer, wherein the barrier layer interacts with the ink to inhibit either or both lateral migration and/or longitudinal migration of the applied ink, and wherein the applied ink ultimately forms at least a portion of the electronic feature.

30. The process of claim 29, wherein the process further comprises the step of:
(c) applying a barrier ink on the base substrate to form the first substrate.

31. The process of claim 30, wherein the process further comprises the step of:
(c) curing or heating the barrier ink under conditions effective to form the barrier layer.

32. The process of claim 29, wherein the electronic feature is selected from the group consisting of a conductor, a resistor, a capacitor, an inductor, a dielectric and a semiconductor.

33. A process for forming at least a portion of an electronic feature, the process comprising the steps of:
(a) providing a substrate;
(b) applying a first layer on the substrate, wherein the first layer comprises an adhesion promoter; and
(c) applying a second layer on at least a portion of the first layer, wherein the first layer interacts with the second layer to inhibit one or both of lateral migration of the second layer and/or longitudinal migration of the second layer, and wherein the second layer forms the at least a portion of the electronic feature.

34. The process of claim 33, wherein the first layer interacts with the second layer to inhibit lateral migration of the second layer.

35. The process of claim 33, wherein the first layer interacts with the second layer to inhibit longitudinal migration of the second layer.

36. The process of claim 35, wherein the first layer interacts with the second layer to inhibit lateral migration of the second layer.

37. The process of claim 33, wherein the substrate is selected from the group consisting of FR4, a fluorinated polymer, a polyimide, an epoxy resin, a polycarbonate, a polyester, polyethylene, polypropylene, polyvinyl chloride, ABS copolymer, wood, paper, metallic foil, glass, flexible fiberboard, non-woven polymeric fabric, and cloth.

38. The process of claim 33, wherein the adhesion promoter is selected from the group consisting of a polymer, PVP, a micro-mechanical adhesion promoter, silica, alumina, HF, an imide, and an ester.

39. The process of claim 33, wherein the second layer comprises a metal selected from the group consisting of silver, gold, copper, nickel, rhodium, palladium and platinum.

40. The process of claim 33, wherein the electronic feature is selected from the group consisting of a conductor, a resistor, a capacitor, an inductor, a dielectric and a semiconductor.

41. A process for forming at least a portion of an electronic feature, the process comprising the steps of:
(a) providing a substrate;
(b) forming a first layer on the substrate, wherein the first layer is either cationic or anionic; and
(c) forming a second layer on the first layer, at least in part, wherein the second layer is anionic if the first layer is cationic, wherein the second layer is cationic if the first layer is anionic, wherein the first layer interacts with the second layer at an interface between the first and second layers to inhibit one or both lateral migration and/or longitudinal migration of the second layer, and wherein the second layer forms the at least a portion of the electronic feature.

42. The process of claim 41, wherein the first layer interacts with the second layer to form a barrier composition at an interface between the first and second layers, which barrier composition inhibits either or both lateral migration and/or longitudinal migration of the second layer.

43. The process of claim 42, wherein the barrier composition comprises a gelation or precipitant product of a reaction between a first reactant in the first layer and a second reactant in the second layer.

44. The process of claim 42, wherein the barrier composition inhibits lateral migration of the second layer.

45. The process of claim 42, wherein the barrier composition inhibits longitudinal migration of the second layer.

46. The process of claim 45, wherein the barrier composition inhibits lateral migration of the second layer.

47. The process of claim 41, wherein the substrate is selected from the group consisting of FR4, a fluorinated polymer, a polyimide, an epoxy resin, a polycarbonate, a polyester, polyethylene, polypropylene, polyvinyl chloride, ABS copolymer, wood, paper, metallic foil, glass, flexible fiberboard, non-woven polymeric fabric, and cloth.

48. The process of claim 41, wherein the first layer comprises a component selected from the group consisting of: a cationic polymer, a quaternary amine polymer, quarternary PVP, poly allyl chloride, and polyethylene imine.

49. The process of claim 41, wherein the second layer comprises a metal selected from the group consisting of silver, gold, copper, nickel, rhodium, palladium and platinum.

50. The process of claim 41, wherein the electronic feature is selected from the group consisting of a conductor, a resistor, a capacitor, an inductor, a dielectric and a semiconductor.

51. A process for forming at least a portion of an electronic feature, the process comprising the steps of:
(a) providing a substrate;
(b) forming a first layer on the substrate, wherein the first layer comprises a surfactant; and
(c) contacting a second layer with the first layer, at least in part, under conditions effective to cause the second layer to spread laterally to a greater extent than if the second layer were formed on the substrate without the first layer, wherein the second layer forms the at least a portion of the electronic feature.

52. The process of claim 51, wherein the substrate is selected from the group consisting of FR4, a fluorinated polymer, a polyimide, an epoxy resin, a polycarbonate, a polyester, polyethylene, polypropylene, polyvinyl chloride, ABS copolymer, wood, paper, metallic foil, glass, flexible fiberboard, non-woven polymeric fabric, and cloth.

53. The process of claim 51, wherein the surfactant is selected from the group consisting of a fluoronated surfactant, a non-ionic surfactant, and a charged surfactant.

54. The process of claim 51, wherein the second layer comprises a metal selected from the group consisting of silver, gold, copper, nickel, rhodium, palladium and platinum.

55. The process of claim 51, wherein the electronic feature is selected from the group consisting of a conductor, a resistor, a capacitor, an inductor, a dielectric and a semiconductor.
